(19) United States
(12) Patent Application Publication
(10) Pub. No.: US 2025/0184972 A1
(43) Pub. Date: Jun. 5, 2025

(54) Signal processing system and method for integrated communication and sensing

(71) Applicant: BEIJING UNIVERSITY OF POSTS AND TELECOMMUNICATIONS, Beijing (CN)

(72) Inventors: Zhiyong FENG, Beijing (CN); Xu CHEN, Beijing (CN); Ping ZHANG, Beijing (CN); Zhiqing WEI, Beijing (CN); Qixun ZHANG, Beijing (CN); Shuo CHANG, Beijing (CN)

(73) Assignee: BEIJING UNIVERSITY OF POSTS AND TELECOMMUNICATIONS, Beijing (CN)

(21) Appl. No.: 18/799,567

(22) Filed: Aug. 9, 2024

(30) Foreign Application Priority Data
Dec. 4, 2023 (CN) 202311650581.9

(51) Int. Cl. H04W 72/0446; H04W 72/23

(52) U.S. Cl. CPC H04W 72/0446; H04W 72/23

(57) ABSTRACT

A signal processing system and method for integrated communication and sensing includes a terminal and an access device. The terminal performs uplink transmission beamforming and management by using fused sensing information, and sends an uplink signal in an uplink time slot. The access device receives the uplink signal in the uplink time slot and receives an echo signal of a downlink signal in a downlink time slot; and performs incident angle estimation, performs reception beamforming and management, performs range and Doppler frequency shift estimation by using fused sensing information to obtain first sensing information of the uplink signal and second sensing information of the echo signal; updates the fused sensing information based on the first sensing information and the second sensing information; performs downlink transmission beamforming and management by using the fused sensing information, and sends a downlink signal in a downlink time slot.

### TECHNICAL FIELD

The present application relates to the field of communication technology, particularly to a signal processing system and method for integrated communication and sensing.

### BACKGROUND

With the rapid development of wireless communication technology, the spectrum allocated for wireless communication continues to develop towards high frequency bands and large bandwidth. Especially after the opening of the millimeter wave frequency band, the spectrum for wireless communication and the spectrum allocated for wireless sensing show an increasingly obvious trend of fusion. With the rapid development of digital signal processing technology, an ADC (Analog to Digital Converter), a DAC (Digital to Analog Converter), and digital processor modules of a wireless sensing system and a wireless communication system are constantly moving forward, and system structures of the wireless sensing system and the wireless communication system are becoming more and more similar. These provide enormous possibilities for integrated communication and sensing technologies that allow a detection sensing system to share hardware equipment, RF links, and spectrum resources with a communication system.

At present, the integrated communication and sensing system based on wireless communication is designed based on a one-way communication process. For example, in the integrated communication and sensing system based on mobile cellular communication, the system is designed based on a certain one-way communication process of uplink or downlink, and the performance improvement of the communication optimization process is limited.

### SUMMARY

The object of embodiments of the present application is to provide a signal processing system and method for integrated communication and sensing to achieve integrated communication and sensing in two-way communication process and further improve the performance of communication optimization process. The specific technical solution is as follows:

In a first aspect, an embodiment of the present application provides a signal processing system for integrated communication and sensing, wherein the system comprises a first signal processing module, a sensing fusion module, a first signal transmission module that are deployed on an access device, and a second signal transmission module deployed on a terminal side, wherein the first signal processing module is connected to the sensing fusion module, and the sensing fusion module is connected to the first signal transmission module;
wherein the second signal transmission module is configured for performing uplink transmission beamforming and management by using fused sensing information, and sending an uplink signal in an uplink time slot based on the uplink transmission beamforming and management;
the first signal processing module is configured for receiving the uplink signal in the uplink time slot and receiving an echo signal of a downlink signal in a downlink time slot, and performing incident angle estimation, performing reception beamforming and management, performing range and Doppler frequency shift estimation on the uplink signal and the echo signal respectively by using the fused sensing information to obtain first sensing information of the uplink signal and second sensing information of the echo signal;
the sensing fusion module is configured for updating the fused sensing information based on the first sensing information and the second sensing information;
the first signal transmission module is configured for performing downlink transmission beamforming and management by using the fused sensing information, and sending a downlink signal in a downlink time slot based on the downlink transmission beamforming and management.

In some embodiments, the uplink signal includes an uplink pilot signal and an uplink data signal, and the downlink signal includes a downlink pilot signal and a downlink data signal;
the system further includes a first channel estimation module, a CSI (Channel State Information) fusion module, and a first communication demodulation module that are deployed on the access device, and a second signal processing module, a second channel estimation module, and a second communication demodulation module that are deployed on the terminal side, wherein the first channel estimation module and the first communication demodulation module are respectively connected to the first signal processing module, the CSI fusion module is connected to the first channel estimation module, and the second channel estimation module and the second communication demodulation module are respectively connected to the second signal processing module;
wherein the first channel estimation module is configured for performing, after receiving the uplink pilot signal, channel estimation on the uplink pilot signal to obtain an uplink CSI estimation value;
the second signal processing module is configured for receiving the downlink signal in the downlink time slot; performing downlink reception beamforming and management on the downlink signal by using the fused sensing information;
the second channel estimation module is configured for performing, after receiving the downlink pilot signal, channel estimation on the downlink pilot signal to obtain a downlink CSI estimation value;
the CSI fusion module is configured for updating a fused CSI estimation value based on the uplink CSI estimation value and the downlink CSI estimation value;
the first communication demodulation module is configured for demodulating, after receiving the uplink data signal, the uplink data signal by using the fused CSI estimation value;
the second communication demodulation module is configured for demodulating, after receiving the downlink data signal, the downlink data signal by using the fused CSI estimation value.

In some embodiments, the CSI fusion module is specifically configured for:
estimating error values corresponding to the uplink CSI estimation value and the downlink CSI estimation value by using a matrix of received signals;
fusing the uplink CSI estimation value and the downlink CSI estimation value by using the obtained error values, to obtain the fused CSI estimation value.

In some embodiments, the downlink signal includes a downlink pilot signal, a downlink data signal, and an active detection signal;
wherein the first signal transmission module is specifically configured for sending the downlink pilot signal and the downlink data signal in the direction of the terminal in a downlink time slot, and sending the active detection signal in a direction of interest in the downlink time slot;
the first signal processing module is specifically configured for receiving an echo signal of the downlink pilot signal, an echo signal of the downlink data signal, and an echo signal of the active detection signal in the downlink time slot.

In some embodiments, the first sensing information and the second sensing information include sensing information corresponding to multiple targets; wherein the sensing fusion module is specifically configured for:
estimating a signal-to-noise ratio of each target for sensing by using a matrix of received signals;
estimating an error value of the sensing information corresponding to each target by using the signal-to-noise ratio of each target for sensing; and
fusing the sensing information corresponding to each target by using the error value corresponding to each target to obtain the fused sensing information.

In some embodiments, the second signal transmission module is specifically configured for performing uplink transmission beamforming and management by using the fused sensing information and the fused CSI estimation value;
the first signal processing module is specifically configured for performing reception beamforming and management by using the fused sensing information and the fused CSI estimation value;
the first signal transmission module is specifically configured for performing downlink transmission beamforming and management by using the fused sensing information and the fused CSI estimation value; and
the second signal processing module is specifically configured for performing downlink reception beamforming and management by using the fused sensing information and the fused CSI estimation value.

In some embodiments, the first signal processing module and the first signal transmission module are specifically configured for:
determining whether it is in a beamforming stage;
if so, generating a reference channel by using the fused sensing information; generating a first function by using the reference channel and the fused CSI estimation value, and generating a second function by using the reference channel and information about a direction of interest, wherein the first function comprises objective and constraint functions of a communication beam, and the second function comprises objective and constraint functions of a dedicated sensing beam; and solving the first function and second function to obtain a communication beamforming vector and a dedicated sensing beamforming vector;
if not, assisting in beam alignment by using the fused sensing information; after the beam alignment, assisting in beam tracking by using the fused sensing information.

In some embodiments, an uplink reception communication beamforming vector and a downlink transmission communication beamforming vector are the same.

In a second aspect, an embodiment of the present application provides a signal processing method for integrated communication and sensing, which is applied to an access device, the method includes:
receiving an uplink signal in an uplink time slot and receiving an echo signal of a downlink signal in a downlink time slot;
performing incident angle estimation, performing reception beamforming and management, performing range and Doppler frequency shift estimation on the uplink signal and the echo signal respectively by using fused sensing information to obtain first sensing information of the uplink signal and second sensing information of the echo signal;
updating the fused sensing information based on the first sensing information and the second sensing information;
performing downlink transmission beamforming and management by using the fused sensing information, and sending a downlink signal in a downlink time slot based on the downlink transmission beamforming and management.

In some embodiments, the uplink signal includes an uplink pilot signal and an uplink data signal, the method further includes:
performing, after receiving the uplink pilot signal, channel estimation on the uplink pilot signal to obtain an uplink CSI estimation value; updating a fused CSI estimation value based on the uplink CSI estimation value and a downlink CSI estimation value; demodulating, after receiving the uplink data signal, the uplink data signal by using the fused CSI estimation value.

In some embodiments, updating the fused CSI estimation value based on the uplink CSI estimation value and the downlink CSI estimation value includes:
estimating error values corresponding to the uplink CSI estimation value and the downlink CSI estimation value by using a matrix of received signals; fusing the uplink CSI estimation value and the downlink CSI estimation value by using the obtained error values, to obtain the fused CSI estimation value.

In some embodiments, the downlink signal includes the downlink pilot signal, the downlink data signal, and an active detection signal; sending a downlink signal in a downlink time slot includes:
sending the downlink pilot signal and downlink data signal in the direction of the terminal in the downlink time slot, and sending the active detection signal in the direction of interest in the downlink time slot;
receiving an echo signal of the downlink signal in the downlink time slot includes:
receiving an echo signal of the downlink pilot signal, an echo signal of the downlink data signal, and an echo signal of the active detection signal in the downlink time slot.

In some embodiments, the first sensing information and the second sensing information include sensing information corresponding to multiple targets; updating the fused sensing information based on the first sensing information and the second sensing information includes:
estimating a signal-to-noise ratio of each target for sensing by using a matrix of received signals; estimating an error value of the sensing information corresponding to each target by using the signal-to-noise ratio of each target for sensing; and fusing the sensing information corresponding to each target by using the error value corresponding to each target to obtain the fused sensing information.

In some embodiments, the reception beamforming and management is performed by the following manners: performing reception beamforming and management by using the fused sensing information and the fused CSI estimation value;
wherein performing downlink transmission beamforming and management by using the fused sensing information includes: performing downlink transmission beamforming and management by using the fused sensing information and the fused CSI estimation value.

In some embodiments, performing reception beamforming and management by using the fused sensing information and the fused CSI estimation value includes: determining whether it is in a beamforming stage; if so, generating a reference channel by using the fused sensing information; generating a first function by using the reference channel and the fused CSI estimation value, and generating a second function by using the reference channel and information about a direction of interest, wherein the first function comprises objective and constraint functions of a communication beam, and the second function comprises objective and constraint functions of a dedicated sensing beam; and solving the first function and second function to obtain a communication beamforming vector and a dedicated sensing beamforming vector; if not, assisting in beam alignment by using the fused sensing information; after the beam alignment, assisting in beam tracking by using the fused sensing information;
performing downlink transmission beamforming and management by using the fused sensing information and the fused CSI estimation value includes: determining whether it is in a beamforming stage; if so, generating a reference channel by using the fused sensing information; generating a first function by using the reference channel and the fused CSI estimation value, and generating a second function by using the reference channel and information about a direction of interest, wherein the first function comprises objective and constraint functions of a communication beam, and the second function comprises objective and constraint functions of a dedicated sensing beam; and solving the first function and second function to obtain a communication beamforming vector and a dedicated sensing beamforming vector; if not, assisting in beam alignment by using the fused sensing information; after the beam alignment, assisting in beam tracking by using the fused sensing information.

In some embodiments, an uplink reception communication beamforming vector and a downlink transmission communication beamforming vector are the same.

In a third aspect, an embodiment of the present application provides a signal processing method for integrated communication and sensing, which is applied to a terminal, the method includes:
performing uplink transmission beamforming and management by using fused sensing information; and sending an uplink signal in an uplink time slot based on the uplink transmission beamforming and management.

In some embodiments, a downlink signal includes a downlink pilot signal and a downlink data signal, the method further includes:
receiving the downlink signal in a downlink time slot; performing downlink reception beamforming and management on the downlink signal by using the fused sensing information; after receiving the downlink pilot signal, performing channel estimation on the downlink pilot signal to obtain a downlink CSI estimation value; after receiving the downlink data signal, demodulating the downlink data signal by using an fused CSI estimation value.

In some embodiments, performing uplink transmission beamforming and management by using fused sensing information includes:
performing uplink transmission beamforming and management by using the fused sensing information and the fused CSI estimation value;
performing downlink reception beamforming and management on the downlink signal by using the fused sensing information includes:
performing downlink reception beamforming and management on the downlink signal by using the fused sensing information and the fused CSI estimation value.

In a fourth aspect, an embodiment of the present application further provides an access device, which comprises a processor, a communication interface, a memory, and a communication bus, wherein the processor, the communication interface, and the memory communicate with each other through the communication bus,
the memory, configured for storing a computer program;
the processor, configured for, when executing the program stored on the memory, implementing the method steps described in the above second aspect.

In a fifth aspect, an embodiment of the present application further provides a terminal, which comprises a processor, a communication interface, a memory, and a communication bus, wherein the processor, the communication interface, and the memory communicate with each other through the communication bus,
the memory, configured for storing a computer program;
the processor, configured for, when executing the program stored on the memory, implementing the method steps described in the above third aspect.

In a sixth aspect, an embodiment of the present application provides a computer-readable storage medium, which stores a computer program thereon that when executed by a processor, implements the method steps described in the second or third aspect.

In a seventh aspect, an embodiment of the present application provides a computer program product containing instructions that, when running on a computer, causes the computer to carry out the method steps described in the second or third aspect.

Beneficial effects of embodiments of the present application are as follows:

In the technical solution provided by the embodiment of the present application, the access device, with the assistance of the obtained fused sensing information, performs incident angle estimation, reception beamforming and management, and range and Doppler frequency shift estimation on a received uplink signal and a received echo signal through a first signal processing module, to obtain new sensing information, i.e. first sensing information and second sensing information. The access device updates the fused sensing information based on the newly obtained sensing information through the sensing fusion module, in order to obtain fused sensing information with higher accuracy, and with the assistance of higher accuracy fused sensing information, transmits a downlink signal through the first signal transmission module. Since the access device and the terminal communicate in extremely short continuous transmission and reception time slots, the state of each target (such as a terminal and an environmental reflector) in the environment remain basically unchanged. Therefore, the obtained fused sensing information can be used to process the received signals, thereby improving the accuracy of signal processing. In addition, new sensing information is obtained through the received signals to update the fused sensing information, thereby improving the accuracy of the fused sensing information. Furthermore, by using the updated fused sensing information to assist downlink signal transmission, the integrated communication and sensing in the two-way communication process is achieved, further improving the environmental sensing ability and improving the performance of the communication optimization process.

Of course, it is not necessary for any product or method implementing the present application to achieve all the advantages described above simultaneously.

### BRIEF DESCRIPTION OF THE DRAWINGS

In order to more clearly describe the technical solutions in the embodiments of the present application or the prior art, accompanying drawings that need to be used in the embodiments or the prior art will be briefly described below. Obviously, accompanying drawings described below are for only some of the embodiments of the present application. For those skilled in the art, they may also obtain other embodiments based on these drawings.

FIG. 1 is a first structure schematic diagram of a signal processing system for integrated communication and sensing provided by an embodiment of the present application;

FIG. 2 is a second structure schematic diagram of the signal processing system for integrated communication and sensing provided by an embodiment of the present application;

FIG. 3 is a third structure schematic diagram of the signal processing system for integrated communication and sensing provided by an embodiment of the present application;

FIG. 4 is a schematic diagram of a processing flow of a CSI fusion module provided by an embodiment of the present application;

FIG. 5 is a schematic diagram of a processing flow of a sensing fusion module provided by an embodiment of the present application;

FIG. 6 is a schematic diagram of a processing flow of a beamforming and management submodule provided by an embodiment of the present application;

FIG. 7 is a schematic diagram of a scenario where two-way integrated communication and sensing between transmission and reception provided by an embodiment of the present application;

FIG. 8 is a fourth structure schematic diagram of the signal processing system for integrated communication and sensing provided by an embodiment of the present application;

FIG. 9 is a fifth structure schematic diagram of the signal processing system for integrated communication and sensing provided by an embodiment of the present application;

FIG. 10 is a sixth structure schematic diagram of the signal processing system for integrated communication and sensing provided by an embodiment of the present application;

FIG. 11 is a seventh structure schematic diagram of the signal processing system for integrated communication and sensing provided by an embodiment of the present application;

FIG. 12 is an eighth structure schematic diagram of the signal processing system for integrated communication and sensing provided by an embodiment of the present application;

FIG. 13 is a flow schematic diagram of a signal processing method for integrated communication and sensing provided by an embodiment of the present application;

FIG. 14 is a structure schematic diagram of an access device provided by an embodiment of the present application;

FIG. 15 is a structure schematic diagram of a terminal provided by an embodiment of the present application.

### DETAILED DESCRIPTION

The technical solutions in the embodiments of the present application will be clearly and completely described below with reference to the accompanying drawings in the embodiments of the present application. Obviously, the described embodiments are only some, and not all, of the embodiments of the present application. All other embodiments obtained based on the embodiments of the present application those skilled in the art without any creative efforts fall into the scope of protection of the present application.

With the rapid development of wireless communication technology, the spectrum allocated for wireless communication continues to develop towards high frequency bands and large bandwidth. Especially after the opening of the millimeter wave frequency band, the spectrum for wireless communication and the spectrum allocated for wireless sensing show an increasingly obvious trend of fusion. With the rapid development of digital signal processing technology, an ADC (Analog to Digital Converter), a DAC (Digital to Analog Converter), and digital processor modules of a wireless sensing system and a wireless communication system are constantly moving forward, and system structures of the wireless sensing system and the wireless communication system are becoming more and more similar. These provide enormous possibilities for integrated communication and sensing technologies that allow a detection sensing system to share hardware equipment, RF links, and spectrum resources with a communication system.

Currently, the integrated communication and sensing system based on wireless communication is designed based on a one-way communication process. For example, in the integrated communication and sensing system based on mobile cellular communication, the system is designed based on a certain one-way communication process of uplink or downlink, ignoring the alternating characteristic of transmission and reception time slots in TDD (Time Division Duplex) communication systems.

Since the existing research on a method for integrated communication and sensing applicable to uplink or downlink is conducted independently and separately, a proposed system for integrated communication and sensing is only applicable to wireless communication links based on uplink or downlink, and does not adapt to the alternating characteristics of uplink and downlink communication in the communication system, nor does it take into account the adaptation of integrated communication and sensing in uplink and downlink, resulting in limited performance improvement in the communication optimization process.

In order to achieve the integrated communication and sensing in a two-way communication process and further improve the performance of the communication optimization process, an embodiment of the present application provides a signal processing system for integrated communication and sensing, which can be applicable to any wireless communication network with continuous two-way transmission and reception time slots, such as cellular mobile communication network, Wi-Fi (wireless network communication technology) network, self-organizing (ad-hoc) network, etc., and can also be applicable to a wireless communication network scenario in single user or multiple users cases, which is not limited. For ease of description, the following description is made by taking a mobile communication network scenario in which uplink and downlink communication processes alternate under a single user and single link condition as an example. For the mobile communication network, the uplink and downlink time slots are referred to as transmission and reception time slots.

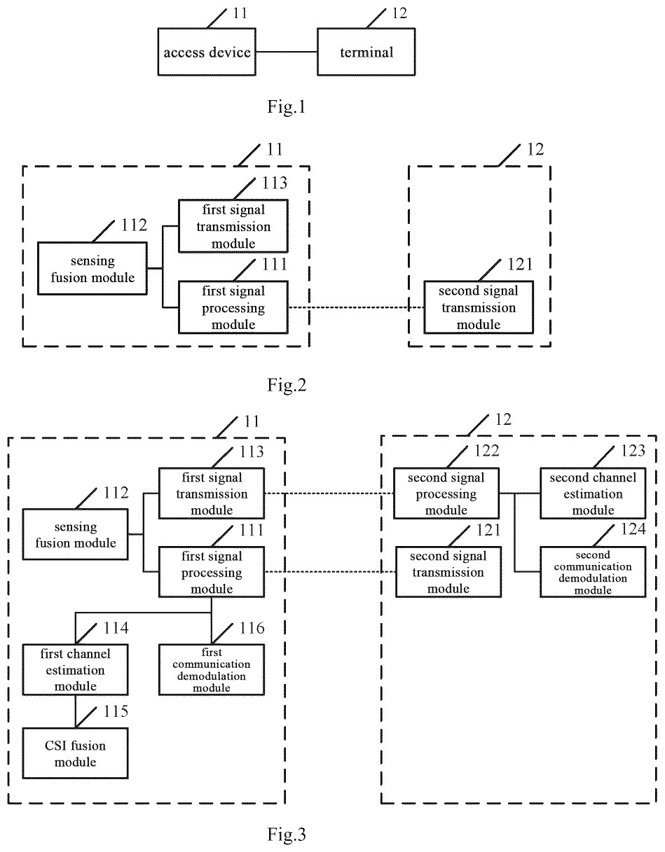

Refer to FIG. 1, which is a first structure schematic diagram of the signal processing system for integrated communication and sensing provided by an embodiment of the present application, the system includes wireless devices on both sides of an access device 11 and a terminal 12. The access device can be a base station or an AP (Access Point), etc., and the terminal can be a User Equipment (UE), etc. In the embodiments of the present application, the access device and terminal can be replaced by any wireless device in the wireless communication network with continuous two-way transmission and reception time slots mentioned above. Here, the access device and terminal are used as examples for illustration and are not limiting.

Referring to FIG. 2, which is a second structure schematic diagram of the signal processing system for integrated communication and sensing provided by an embodiment of the present application, the system includes a first signal processing module 111, a sensing fusion module 112, and a first signal transmission module 113 that are deployed on an access device, as well as a second signal transmission module 121 deployed on a terminal side, wherein the first signal processing module 111 is connected to the sensing fusion module 112, and the sensing fusion module 112 is connected to the first signal transmission module 113.

The second signal transmission module 121 is configured for performing uplink transmission beamforming and management by using fused sensing information, and sending an uplink signal in an uplink time slot based on the uplink transmission beamforming and management.

In the embodiment of the present application, the fused sensing information is more accuracy sensing information obtained by the access device fusing multiple pieces of sensing information through the sensing fusion module 112. The access device can feedback the fused sensing information to the terminal through a downlink signal and store the fused sensing information in the sensing fusion module of the terminal. In an uplink time slot, the terminal can use the fused sensing information provided by the sensing fusion module 112 of the access device as prior information through the second signal transmission module 121, and with the assistance of the fused sensing information, the terminal can perform uplink transmission beamforming and management on the uplink signal to obtain an uplink transmission communication beamforming vector, and send the uplink signal to the access device. In addition, if the sensing fusion module 112 of the access device has not yet obtained the fused sensing information, the second signal transmission module 121 can directly perform uplink transmission beamforming and management, by using such as the Least Square (LS) or other beamforming methods to obtain the uplink transmission communication beamforming vector.

The first signal processing module 111 is configured for receiving the uplink signal in the uplink time slot and receiving an echo signal of a downlink signal in a downlink time slot, and performing incident angle estimation, performing reception beamforming and management, performing range and Doppler frequency shift estimation on the uplink signal and the echo signal respectively by using the fused sensing information to obtain first sensing information of the uplink signal and second sensing information of the echo signal.

In the uplink time slot, the access device receives an uplink signal passing through an uplink communication channel through the first signal processing module 111, and uses the received uplink signal to perform sensing information estimation, such as incident angle estimation, distance estimation, and Doppler frequency shift estimation, to estimate an AoA (Angle-of-arrival) of the terminal and an environmental reflector, a distance between the terminal and the access device and a radial relative motion speed, so as to obtain angle sensing information, distance sensing information, and frequency shift sensing information as first sensing information. The access device uses the fused sensing information provided by the sensing fusion module 112 as prior information through the first signal processing module 111, and with the assistance of the current fused sensing information, the access device performs uplink reception beamforming and management on the uplink signal, such as performing reception beamforming or beam management on the uplink signal, to generate an uplink reception communication beamforming vector for baseband spatial filtering.

Similarly, the access device can process an echo signal in the downlink time slot. In the downlink time slot, the access device receives an echo signal of a downlink signal passing through an echo sensing channel through the first signal processing module 111, and uses the echo signal to perform sensing information estimation, such as incident angle estimation, distance estimation, and Doppler frequency shift estimation, to estimate an AoA of the terminal and an environmental reflector, as well as a distance between the terminal and the access device and a radial relative motion speed, so as to obtain angle sensing information, distance sensing information, and frequency shift sensing information as second sensing information. The access device uses the fused sensing information provided by the sensing fusion module 112 as prior information through the first signal processing module 111, and with the assistance of the current fused sensing information, the access device performs downlink reception beamforming and management on the echo signal, such as performing reception beamforming or beam management on the echo signal to generate an downlink reception beamforming vector for baseband spatial filtering. There is no limitation on the order in which the first signal processing module 111 estimates sensing information, and performs reception beamforming and management.

In the embodiment of the present application, there may be multiple environmental reflectors in the environment, the first signal processing module 111 can receive multiple echo signals in the downlink time slot, and process the multiple echo signals in the above manner, so that second sensing information of multiple environmental reflectors can be obtained.

The sensing fusion module 112 is configured for updating the fused sensing information based on the first sensing information and the second sensing information.

In the embodiment of the present application, the access device updates the current fused sensing information based on the obtained sensing information (such as the first sensing information and second sensing information) through the sensing fusion module 112. For example, if the fused sensing information has been obtained, after obtaining the first sensing information, the sensing fusion module 112 can fuse the first sensing information with the current fused sensing information, to obtain fused sensing information after fusing as new fused sensing information; if the fused sensing information has not been obtained yet, the first sensing information can be used as the fused sensing information. Similarly, after obtaining the second sensing information in the downlink time slot, the sensing fusion module 112 can fuse the second sensing information with the current fused sensing information to update the fused sensing information.

The first signal transmission module 113 is used to performing downlink transmission beamforming and management by using the fused sensing information, and sending a downlink signal in a downlink time slot based on the downlink transmission beamforming and management.

In the downlink time slot, the access device can use fused sensing information provided by the sensing fusion module 112 as prior information through the first signal transmission module 113, and with the assistance of the current fused sensing information, the access device can perform downlink transmission beamforming and management on the downlink signal and send the downlink signal to the terminal. If the sensing fusion module 112 of the access device has not yet obtained the fused sensing information, the second signal transmission module 121 can directly perform uplink transmission beamforming and management.

In the technical solution provided by the embodiment of the present application, the access device, with the assistance of the obtained fused sensing information, performs incident angle estimation, performs reception beamforming and management, and performs distance estimation and Doppler frequency shift estimation on the received uplink signal and echo signal through the first signal processing module, to obtain new sensing information, i.e., the first sensing information and the second sensing information. The access device updates the fused sensing information based on the newly obtained sensing information through the sensing fusion module, so as to obtain fused sensing information with higher accuracy, and transmits a downlink signal through the first signal transmission module with the assistance of fused sensing information with higher accuracy. Since the access device and the terminal communicate in extremely short continuous transmission and reception time slots, the state of each target (such as the terminal, the environmental reflector) in the environment remain basically unchanged. Therefore, the obtained fused sensing information can be used to process the received signals, thereby improving the accuracy of signal processing. In addition, new sensing information is obtained through the received signals to update the fused sensing information, thereby improving the accuracy of the fused sensing information. Furthermore, by using the updated fused sensing information to assist downlink signal transmission, the integrated communication and sensing in the two-way communication process is achieved, further improving the environmental sensing ability and improving the performance of the communication optimization process.

In the embodiment of the present application, the first signal transmission module 113 and the second signal transmission module 121 may include an OFDM (Orthogonal frequency-division multiplexing) signal generation submodule and a beamforming and management submodule. The terminal can generate an uplink signal through the OFDM signal generation module, then perform uplink transmission beamforming and management on the uplink signal through the beamforming and management submodule, and send the uplink signal to the access device. The access device can generate a downlink signal through the OFDM signal generation module, then perform downlink transmission beamforming and management on the downlink signal through the beamforming and management submodule, and send the downlink signal to the terminal.

In the embodiment of the present application, the first signal processing module 111 may include an incident angle estimation submodule, a beamforming and management submodule, and a range-Doppler frequency shift estimation submodule, which respectively perform incident angle estimation, reception beamforming and management, and range and Doppler frequency shift estimation on the uplink signal and echo signal. The performing order of each module is not limited here. The following description is made when the access device performs incident angle estimation, reception beamforming and management, range and Doppler frequency shift estimation on the uplink signal sequentially as an example, which is not limited.

After receiving an uplink signal in the uplink time slot, the access device can perform incident angle estimation on the uplink signal through the incident angle estimation submodule to obtain angle sensing information, then perform uplink reception beamforming and management through the beamforming and management submodule with the assistance of the current fused sensing information, then perform, through the range-Doppler frequency shift estimation submodule, distance estimation and Doppler frequency shift estimation on the uplink signal on which uplink reception beamforming and management is performed, so as to obtain distance sensing information and frequency shift sensing information. Similarly, the access device can process the echo signal, and there is no limitation to the manner that the access device processes the uplink signal and echo signal.

In the embodiment of the present application, if the sensing fusion module 112 of the access device has not yet obtained fused sensing information, the beamforming and management submodule can perform reception beamforming and management based on the obtained angle sensing information; if the sensing fusion module 112 of the access device has obtained fused sensing information, the beamforming and management submodule can perform reception beamforming and management based on the obtained angle sensing information and fused sensing information, which is not limited.

In the embodiment of the present application, the incident angle estimation submodule can use an array of received signals (i.e. the uplink signal or echo signal), to estimate incident angles of different signal components, i.e. AoA. The incident angle estimation submodule can perform incident angle estimation by using multiple signal classification (MUSIC), estimating signal parameter via rotational invariance techniques (ESPRIT), and other methods.

In the embodiment of the present application, the range-Doppler frequency shift estimation submodule can use an array of received signals (i.e. the uplink signal or echo signal) to estimate range and Doppler frequency shift parameters in the channel. The range-Doppler frequency shift estimation submodule can adopt a range and Doppler sensing method based on Fast Fourier Transform (FFT), a range and Doppler sensing method based on subspace method (such as MUSIC, ESPRIT, etc.), and a range and Doppler sensing method based on tensor estimation. For the case that the sensing accuracy is not high, the range and Doppler sensing method based on FFT can be used for low complexity estimation; for the case that high complexity is not required but high sensing accuracy and resolution are required, the range and Doppler sensing method based on subspace or tensor estimation can be used.

In some embodiments, the uplink signal includes an uplink pilot signal and an uplink data signal, and the downlink signal includes a downlink pilot signal and a downlink data signal. Referring to FIG. 3, which is a third structure schematic diagram of the signal processing system for integrated communication and sensing provided by an embodiment of the present application, wherein the signal processing system for integrated communication and sensing further includes a first channel estimation module 114, a CSI fusion module 115, and a first communication demodulation module 116 that are deployed on an access device, as well as a second signal processing module 122, a second channel estimation module 123, and a second communication demodulation module 124 that are deployed on a terminal side, and wherein the first channel estimation module 114 and the first communication demodulation module 116 are respectively connected to the first signal processing module 111, the CSI fusion module 115 is connected to the first channel estimation module 114, the second channel estimation module 123 and the second communication demodulation module 124 are respectively connected to the second signal processing module 122.

The first channel estimation module 114 is configured for performing, after receiving the uplink pilot signal, channel estimation on the uplink pilot signal to obtain an uplink CSI estimation value.

In an uplink preamble symbol time slot, the terminal performs uplink transmission beamforming and management on the uplink pilot signal through the second signal transmission module 121 with the assistance of fused sensing information, and sends the uplink pilot signal to the access device. The access device receives the uplink pilot signal passing through the uplink communication channel through the first signal processing module 111, performs incident angle estimation, uplink reception beamforming and management, range and Doppler frequency shift estimation on the uplink pilot signal, to obtain first sensing information and an uplink reception communication beamforming vector, and updates the fused sensing information through the sensing fusion module 112. Similarly, in the uplink data symbol time slot, the terminal performs uplink transmission beamforming and management on the uplink data signal through the second signal transmission module 121 with the assistance of fused sensing information, and sends the uplink data signal to the access device. The access device receives the uplink data signal passing through the uplink communication channel through the first signal processing module 111, performs incident angle estimation, uplink reception beamforming and management, range and Doppler frequency shift estimation on the uplink data signal, to obtain first sensing information and an uplink reception communication beamforming vector, and updates the fused sensing information through the sensing fusion module 112.

In the embodiment of the present application, after receiving the uplink pilot signal, the first channel estimation module 114 performs uplink channel estimation on the uplink pilot signal on which the first signal processing module 111 has performed uplink reception beamforming and management, to obtain an uplink CSI estimation value.

In the embodiment of the present application, the access device can perform channel estimation by using the received pilot signal to obtain a CSI estimation value for communication demodulation. The access device can use any channel estimation method for channel estimation, such as channel estimation based on least squares, channel estimation based on minimum mean square error (MMSE), and channel estimation based on linear minimum mean square error (LMMSE), etc. The first channel estimation module 114 can also perform channel estimation with the assistance of fused sensing information to improve the accuracy of channel estimation, which is not limited.

In the embodiment of the present application, the terminal can directly use the uplink transmission communication beamforming vector obtained by performing uplink transmission beamforming and management on the uplink pilot signal, as an uplink transmission communication beamforming vector of the uplink data signal for transmitting the uplink data signal, such as using an antenna weight vector that is the same as the uplink transmission communication beamforming vector of the uplink pilot signal for transmitting the uplink data signal. Similarly, the access device can directly use an uplink reception communication beamforming vector obtained by performing uplink reception beamforming and management on the uplink pilot signal, as an uplink reception communication beamforming vector of the uplink data signal for processing the uplink data signal, which is not limited.

In the embodiment of the present application, after receiving the uplink data signal, the access device can only perform high-accuracy incident angle estimation on the uplink data signal, and use the obtained angle sensing information as first sensing information.

The second signal processing module 122 is configured for receiving the downlink signal in the downlink time slot; performing downlink reception beamforming and management on the downlink signal by using the fused sensing information.

In the embodiment of the present application, in a downlink preamble symbol time slot, the access device performs downlink transmission beamforming and management through the first signal transmission module 113 with the assistance of fused sensing information, to obtain a downlink transmission communication beamforming vector, and sends a downlink pilot signal to the terminal. The terminal receives the downlink pilot signal passing through a downlink communication channel, and with the assistance of the fused sensing information feedback from the access device, performs downlink reception beamforming and management on the downlink pilot signal through the second signal processing module 122, to obtain a downlink reception communication beamforming vector. Similarly, in a downlink data symbol time slot, the access device performs downlink transmission beamforming and management through the first signal transmission module 113 with the assistance of fused sensing information, to obtain a downlink transmission communication beamforming vector, and sends the downlink data signal to the terminal. The terminal receives the downlink data signal passing through the downlink communication channel, and with the assistance of the fused sensing information feedback from the access device, performs downlink reception beamforming and management on the downlink data signal through the second signal processing module 122, to obtain a downlink reception communication beamforming vector.

In the embodiment of the present application, the uplink reception communication beamforming vector and the downlink transmission communication beamforming vector can be the same, that is, the access device can directly use the uplink reception communication beamforming vector obtained by performing uplink reception beamforming and management on the uplink pilot signal as a downlink transmission communication beamforming vector of the downlink pilot signal, for transmitting the downlink pilot signal without further beamforming and management, such as using an antenna weight vector that is the same as the uplink reception communication beamforming vector of the uplink pilot signal for transmitting the downlink pilot signal. Due to channel reciprocity of a TDD system, the access device uses the downlink transmission communication beamforming vector which is the same as the uplink reception communication beamforming vector, which can reduce system complexity and save computing resources.

Similarly, the access device can also directly use the downlink transmission communication beamforming vector of the downlink pilot signal as the downlink transmission communication beamforming vector of the downlink data signal for transmitting the downlink data signal. The terminal can directly use the uplink transmission communication beamforming vector obtained by performing uplink transmission beamforming and management on the uplink pilot signal as the downlink reception communication beamforming vector of the downlink pilot signal for receiving the downlink pilot signal. The terminal can also directly use the downlink reception communication beamforming vector of the downlink pilot signal as the downlink reception communication beamforming vector of the downlink data signal for receiving the downlink data signal.

The second channel estimation module 123 is performing, after receiving the downlink pilot signal, channel estimation on the downlink pilot signal to obtain a downlink CSI estimation value.

In the embodiment of the present application, the terminal performs downlink channel estimation through the second channel estimation module 123 on the downlink pilot signal on which the second signal processing module 122 has performed downlink reception beamforming and management, to obtain a downlink CSI estimation value. The specific method of channel estimation can be referred to the relevant description of uplink channel estimation performed by the first channel estimation module 114 mentioned above.

The CSI fusion module 115 is configured for updating a fused CSI estimation value based on the uplink CSI estimation value and the downlink CSI estimation value.

In the embodiment of the present application, the terminal may carry a downlink CSI estimation value in an uplink signal and feedback the downlink CSI estimation value to the access device. Through the CSI fusion module 115, the access device can update the fused CSI estimation value based on the obtained CSI estimation values (such as the uplink CSI estimation value and downlink CSI estimation value). For example, if the access device has obtained the fused CSI estimation value, after obtaining the uplink CSI estimation value, the CSI fusion module 115 can fuse the uplink CSI estimation value with the current fused CSI estimation value, to obtain the fused CSI estimation value after fusing as a new fused CSI estimation value; if the fused CSI estimation value has not been obtained yet, the CSI fusion module 115 can use the obtained uplink CSI estimation value as the fused CSI estimation value. Similarly, after obtaining the downlink CSI estimation value, the CSI fusion module 115 can fuse the downlink CSI estimation value with the current fused CSI estimation value, and update the fused CSI estimation value.

The first communication demodulation module 116 is configured for demodulating, after receiving the uplink data signal, the uplink data signal by using the fused CSI estimation value.

In the embodiment of the present application, after receiving the uplink data signal, the first communication demodulation module 116 uses the fused CSI estimation value to demodulate the uplink data signal on which the first signal processing module 111 has performed the uplink reception beamforming and management.

The access device can use CSI estimation values to perform channel equalization and decoding on the received data signal. The access device can perform communication demodulation by using any channel equalization criteria and decoding criteria, such as using channel equalization criteria based on LS criteria or MMSE criteria, decoding criteria based on Maximum Likelihood (ML) criteria, etc., which is not limited.

The second communication demodulation module 124 is configured for demodulating, after receiving the downlink data signal, the downlink data signal by using the fused CSI estimation value.

In the embodiment of the present application, after receiving the downlink data signal, the second communication demodulation module 124 uses the fused CSI estimation value to demodulate the downlink data signal on which the second signal processing module 122 has performed downlink reception beamforming and management, the specific method of demodulation can be referred to the relevant description of demodulation by the first communication demodulation module 116 mentioned above.

In the technical solution provided by the embodiments of the present application, due to the channel reciprocity of the TDD system within coherent time, the uplink and downlink CSI estimation values can be fused through the CSI fusion module to obtain the fused CSI estimation value. The fused CSI estimation value can be used for communication demodulation to improve the accuracy of channel estimation, thereby improving the communication reliability.

In some embodiments, the downlink signal includes a downlink pilot signal, a downlink data signal, and an active detection signal. The first signal transmission module 113 is specifically configured for sending the downlink pilot signal and downlink data signal in the direction of the terminal in a downlink time slot, and sending the active detection signal in a direction of interest (DoI) in the downlink time slot. The first signal processing module 111 is specifically configured for receiving an echo signal of the downlink pilot signal, an echo signal of the downlink data signal, and an echo signal of the active detection signal in the downlink time slot.

In the embodiment of the present application, in a downlink preamble symbol time slot, the access device performs downlink transmission beamforming and management through the first signal transmission module 113 with the assistance of the fused sensing information, to obtain a downlink transmission communication beamforming vector, and sends the downlink pilot signal in the direction of the terminal. In the downlink preamble symbol time slot, the first signal processing module 111 receives echo signals of the terminal and of the environmental reflector in the direction of the terminal. In the downlink data symbol time slot, the access device performs downlink transmission beamforming and management through the first signal transmission module 113 with the assistance of the fused sensing information, to obtain a downlink transmission communication beamforming vector and a downlink transmission sensing beamforming vector, and sends the downlink data signal and active detection signal in the direction of the terminal and in a direction of interest, respectively. In the downlink data symbol time slot, the first signal processing module 111 receives echo signals of the terminal, of the environmental reflector in the direction of the terminal, and of a potential environmental reflector in the direction of interest. The access device can transmit an active detection signal to a preset direction of interest, or can transmit the active detection signal by scanning, which is not limited.

In the embodiment of the present application, after receiving the echo signals of the downlink pilot signal, of the downlink data signal, and of the active detection signal, the access device can perform incident angle estimation, reception beamforming and management, and range and Doppler frequency shift estimation on each of the echo signals through the first signal processing module 111.

In the technical solution provided by the embodiment of the present application, the first signal transmission module further sends an active detection signal in the direction of interest while sending a downlink signal in the direction of the terminal, so that the access device can detect other directions of interest through the active detection signal, to obtain sensing information of potential environmental reflectors in the environment, thereby enhancing the sensing accuracy and detection rate of targets in the environment.

In some embodiments, the CSI fusion module 115 is specifically configured for estimating error values corresponding to the uplink CSI estimation value and the downlink CSI estimation value by using a matrix of received signals; fusing the uplink CSI estimation value and the downlink CSI estimation value by using the obtained error values, to obtain the fused CSI estimation value. After obtaining the uplink CSI estimation value and downlink CSI estimation value, the CSI fusion module 115 can estimate error values corresponding to CSI estimation values, such as using the matrix of received signals for channel estimation as an input to estimate error values corresponding to the uplink CSI estimation value and downlink CSI estimation value, and an error value can be a mean square error, etc., which not limited here. The CSI fusion module 115 associates a corresponding error value with a CSI estimation result, and performs data fusion on the uplink CSI estimation result and the downlink CSI estimation result, to obtain a fused CSI estimation value with higher accuracy.

In the embodiment of the present application, after obtaining the uplink CSI estimation value, the CSI fusion module 115 can update the fused CSI estimation value based on the uplink CSI estimation value. The CSI fusion module 115 estimates error values corresponding to the uplink CSI estimation value and the current fused CSI estimation value, associates the corresponding error values to CSI estimation results for data fusion, and updates the fused CSI estimation value. Similarly, after obtaining the downlink CSI estimation value, the CSI fusion module 115 can update the fused CSI estimation value based on the downlink CSI estimation value, which will not be repeated here.

In the embodiment of the present application, multiple data fusion methods can be used in the process of fusing the CSI estimation values, such as using a data fusion method based on the minimum variance criterion, as shown in Formula (1). The data fusion of uplink CSI estimation result and downlink CSI estimation result is taken as an example, which is not limited.

$$M = {K}_{1} * {W}_{1} + {K}_{2} * {W}_{2} \qquad Formula ( 1 )$$

wherein, M represents a fused CSI estimation value, W₁ represents an uplink CSI estimation result, W₂ represents a downlink CSI estimation result, K₁ represents a weight of the uplink CSI estimation result, K₁=σ₂²/(σ₁²+σ₂²), σ₂² represents a variance of the downlink CSI estimation result, σ₁² represents a variance of the uplink CSI estimation result, K₂ represents a weight of the downlink CSI estimation result, K₂=σ₁²/(σ₁²+σ₂²).

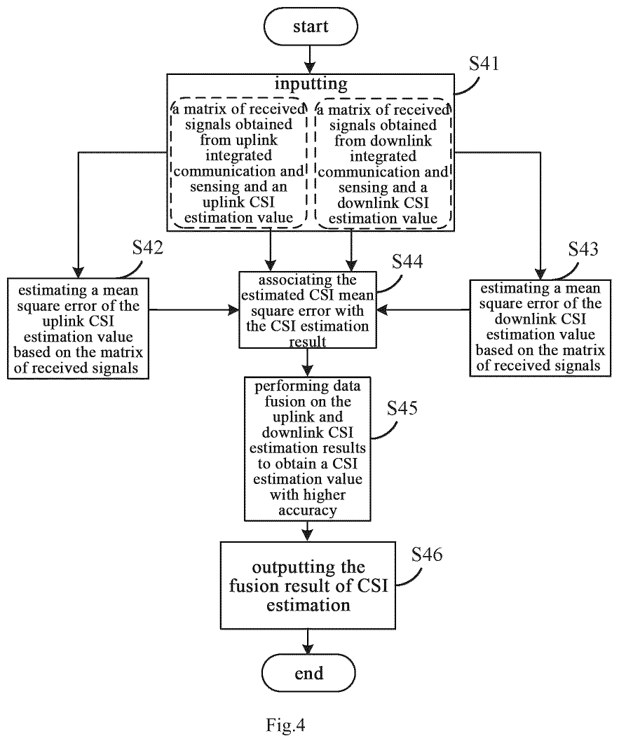

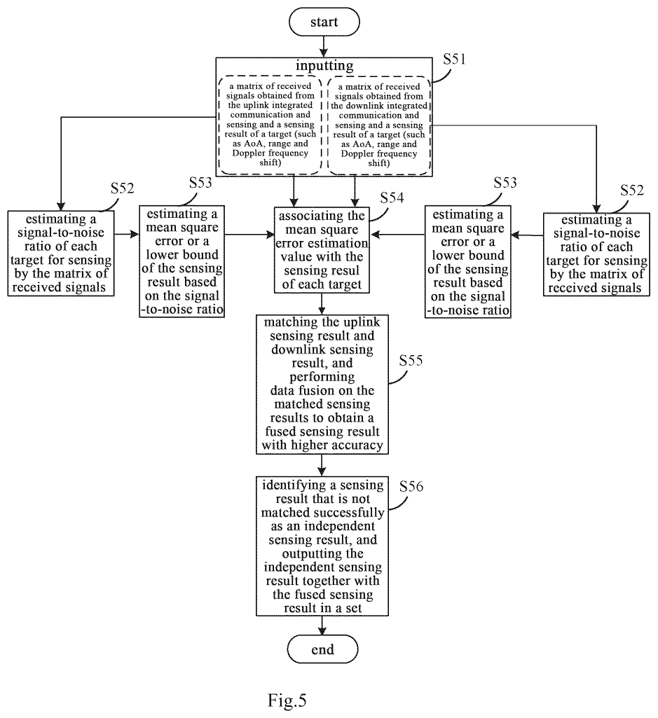

Referring to FIG. 4, which is a schematic diagram of a processing flow of a CSI fusion module provided by an embodiment of the present application.

Step S41, inputting a matrix of received signals obtained from uplink integrated communication and sensing and an uplink CSI estimation value, as well as a matrix of received signals obtained from downlink integrated communication and sensing and a downlink CSI estimation value.

Step S42, estimating a mean square error of the uplink CSI estimation value based on the matrix of received signals.

Step S43, estimating a mean square error of the downlink CSI estimation value based on the matrix of received signals.

Step S44, associating the estimated CSI mean square error with a CSI estimation result.

Step S45, performing data fusion on the uplink and downlink CSI estimation results to obtain a CSI estimation value with higher accuracy.

Step S46, outputting a fusion result of CSI estimation (i.e. the fused CSI estimation value).

In the technical solution provided by the embodiment of the present application, the CSI fusion module takes the obtained uplink and downlink CSI estimation values and the matrix of received signals for channel estimation as input, performs data fusion on CSI of the uplink and downlink communication channels by using the channel reciprocity to obtain a fused CSI estimation value with higher accuracy as output, thereby improving the communication reliability.

In some embodiments, the first sensing information and the second sensing information include sensing information corresponding to multiple targets. The sensing fusion module 112 is specifically configured for: estimating a signal-to-noise ratio of each target for sensing by using the matrix of received signals; estimating an error value of the sensing information corresponding to each target by using the signal-to-noise ratio of each target for sensing; and fusing the sensing information corresponding to each target by using the error value corresponding to each target to obtain the fused sensing information.

After obtaining the first sensing information and the second sensing information, the sensing fusion module 112 can estimate a signal-to-noise ratio of each target for sensing to which all of the sensing information included in the first sensing information and the second sensing information belong, such as using the matrix of received signals for sensing estimation as an input to estimate a signal-to-noise ratio of each target for sensing. Based on the signal-to-noise ratio of each target, the error value of the sensing information corresponding to each target is estimated, and the error value can be a mean square error or a lower bound of mean square error, etc., which is not limited here. The sensing fusion module 112 associates the error value of the sensing information corresponding to each target with a sensing result (i.e. the sensing information) of each target, matches the uplink sensing result (i.e. the first sensing information) and downlink sensing result (i.e. the second sensing information), and performs data fusion on sensing results of the matched targets to obtain a fused sensing result with higher accuracy. For a target that is not matched successfully, the sensing fusion module 112 identifies the sensing result of the target as an independent sensing result, and adds the independent sensing result of the target to a set of fused sensing results. The sensing fusion module 112 outputs the fused sensing result as fused sensing information. In the embodiment of the present application, the target can be a terminal, an environmental reflector, etc., which is not limited.

In the embodiment of the present application, after obtaining the first sensing information, the sensing fusion module 112 can update the fused sensing information based on the first sensing information. The sensing fusion module 112 estimates a signal-to-noise ratio of each target for sensing to which all of the sensing information included in the first sensing information and the fused sensing information belong, and estimates an error value of the sensing information corresponding to each target, associates the error value with the sensing information corresponding to each target for data fusion, and updates the fused sensing information. Similarly, after obtaining the second sensing information, the sensing fusion module 112 can update the fused sensing information based on the second sensing information, which will not be repeated here.

In the embodiment of the present application, multiple data fusion methods can be used in the process of fusing the sensing information, such as using a data fusion method based on the minimum variance criterion, as shown in Formula (2). The data fusion of a first angle sensing result of one target included in the first sensing information and a second angle sensing result of the same target included in the second sensing information is taken as an example, which does not have a limiting effect.

$${M}^{′} = {K}_{1}^{′} * {W}_{1}^{′} + {K}_{2}^{′} * {W}_{2}^{′} \qquad Formula ( 2 )$$

wherein, M′ represents the fused sensing information, W₁′ represents the first angle sensing result, W₂′ represents the second angle sensing result, K₁′ represents a weight of the first angle sensing result, K₁′=σ₂′²/(σ₁′²+σ₂′²), σ₂′² represents a variance of the second angle sensing result, σ₁′² represents a variance of the first angle sensing result, K₂ represents a weight of the second angle sensing result, K₂′=σ₁′²/(σ₁′²+σ₂′²).

Referring to FIG. 5, which is a schematic diagram of a processing flow of a sensing fusion module provided by an embodiment of the present application.

Step S51, inputting a matrix of received signals obtained from the uplink integrated communication and sensing and a sensing result of a target (such as AoA, range and Doppler frequency shift), as well as a matrix of received signals obtained from the downlink integrated communication and sensing and a sensing result of a target (such as AoA, range and Doppler frequency shift).

Step S52, estimating a signal-to-noise ratio of each target for sensing by the matrix of received signals.

Step S53, estimating a mean square error or a lower bound of the sensing result based on the signal-to-noise ratio.

Step S54, associating the mean square error estimation value with the sensing result of each target.

Step S55, matching the uplink sensing result and downlink sensing result, and performing data fusion on the matched sensing results to obtain a fused sensing result with higher accuracy.

Step S56, identifying a sensing result that is not matched successfully as an independent sensing result, and outputting the independent sensing result together with the fused sensing result in a set.

In the technical solution provided by the embodiment of the present application, the sensing fusion module takes the obtained uplink and downlink sensing information, and the matrix of received signals for sensing estimating, as inputs, matches and fuses sensing results of the same target in the uplink and downlink sensing information. Finally, the sensing fusion module outputs unmatched sensing results and the matched fused sensing result in a union to obtain fused sensing information with higher accuracy, which is used to assist enhancing communication performance and to be prior information for application decision.

In some embodiments, the second signal transmission module 121 is specifically configured for performing uplink transmission beamforming and management by using the fused sensing information and the fused CSI estimation value; the first signal processing module 111 is specifically configured for performing reception beamforming and management by using the fused sensing information and the fused CSI estimation value; the first signal transmission module 113 is specifically configured for performing downlink transmission beamforming and management by using the fused sensing information and the fused CSI estimation value; and the second signal processing module 122 is specifically configured for performing downlink reception beamforming and management by using the fused sensing information and the fused CSI estimation value. The access device and the terminal can perform transmission beamforming and management and reception beamforming and management, with the assistance of fused sensing information provided by the sensing fusion module 112 and the fused CSI estimation value provided by the CSI fusion module 115. For example, in the uplink time slot, the second signal transmission module 121 performs uplink transmission beamforming and management on the uplink signal by using the fused sensing information and the fused CSI estimation value, while the first signal processing module 111 performs reception beamforming and management on the uplink signal by using the fused sensing information and the fused CSI estimation value. In the downlink time slot, the first signal transmission module 113 performs downlink transmission beamforming and management on the downlink signal by using the fused sensing information and the fused CSI estimation value, while the second signal processing module 122 performs downlink reception beamforming and management on the echo signal of the downlink signal by using the fused sensing information and the fused CSI estimation value.

In the technical solution provided by the embodiment of the present application, beamforming and management is performed by using the fused sensing information and the fused CSI estimation value with higher accuracy, which further improves sensing performance and enhances communication performance, such as the signal-to-noise ratio and the reliability of uplink and downlink communication.

In some embodiments, the first signal processing module 111 and the first signal transmission module 113 are specifically configured for: determining whether it is in a beamforming stage; if so, generating a reference channel by using the fused sensing information; generating a first function by using the reference channel and the fused CSI estimation value, and generating a second function by using the reference channel and information about a direction of interest, wherein the first function comprises objective and constraint functions of a communication beam, and the second function comprises objective and constraint functions of a dedicated sensing beam; and solving the first function and second function to obtain a communication beamforming vector and a dedicated sensing beamforming vector; if not, assisting in beam alignment by using the fused sensing information; after the beam alignment, assisting in beam tracking by using the fused sensing information.

In the embodiment of the present application, when the access device performs beamforming and management through the first signal processing module 111 and the first signal transmission module 113 (such as the beamforming and management submodule), it determines whether it is in a beamforming stage, that is, determines whether a beamforming vector has been generated. For example, when the signal processing system for integrated communication and sensing is in an initial access state and the beamforming vector has not been generated yet, the beamforming and management submodule is in the beamforming stage.

Since different time slots and different modules perform beamforming and management in different ways, it can be divided into the following situations.

Case 1, in a downlink preamble symbol time slot, the first signal transmission module 113 performs downlink transmission beamforming and management. When the first signal transmission module 113 performs downlink transmission beamforming and management, it determines whether it is currently in a beamforming stage, that is, it determines whether a downlink transmission communication beamforming vector and a downlink transmission sensing beamforming vector have been generated. If the first signal transmission module 113 determines that the downlink transmission communication beamforming vector has not been generated, then the first signal transmission module 113, with the assistance of fused sensing information, generates a communication beamforming vector (i.e. the downlink transmission communication beamforming vector). That is to say, the first signal transmission module 113 uses the fused sensing information to generate a reference channel, and uses the reference channel and the fused CSI estimation value to generate a first function (i.e., objective and constraint functions of a communication beam), maximizes a received power of communication (i.e. a pilot signal and a data signal) and minimizes an interference of sensing (i.e. an environmental reflector) on communication by constructing and solving an optimization problem of the first function, generates the downlink transmission communication beamforming vector, and transmits a downlink pilot signal to the terminal. If the first signal transmission module 113 determines that the downlink transmission sensing beamforming vector has not been generated, then the first signal transmission module 113, with the assistance of fused sensing information, generates a dedicated sensing beamforming vector (i.e. a downlink transmission sensing beamforming vector). That is to say, the first signal transmission module 113 uses the fused sensing information to generate a reference channel, and uses the reference channel and information about a direction of interest (i.e., DoI) to generate a second function (i.e., objective and constraint functions of the dedicated sensing beam), maximizes a power of the sensing signal (i.e. an active detection signal) in the DoI direction and minimizes a mutual interference between the communication direction (i.e., the direction of the terminal) and the DoI direction by constructing and solving an optimization problem of the second function, generates the downlink transmission sensing beamforming vector, and transmits the active detection signal in the DoI direction in the downlink data symbol time slot.

If it is not currently in the beamforming stage, the first signal transmission module 113 performs beam management with the assistance of fused sensing information. That is to say, the first signal transmission module 113 uses the fused sensing information as prior information to assist beam alignment; after the beam alignment, it uses the fused sensing information (i.e., the AOA, range and Doppler frequency shift) for calculation, to obtain position information of the target, constructs a kinematic model, and assists beam tracking.

In the embodiment of the present application, when the uplink reception communication beamforming vector and the downlink transmission communication beamforming vector are the same, in the downlink preamble symbol time slot, the first signal transmission module 113 may not need to determine whether it is in the beamforming stage, but directly use the uplink reception communication beamforming vector obtained by the first signal processing module 111 as the downlink transmission communication beamforming vector.

Case 2, in the uplink time slot (including the uplink preamble symbol time slot and the uplink data symbol time slot), the first signal processing module 111 performs uplink reception beamforming and management. In the uplink time slot, the first signal processing module 111 only receives the uplink signal, and the first signal processing module 111 determines whether the uplink reception communication beamforming vector has been generated. If the uplink reception communication beamforming vector has not been generated, the first signal processing module 111 only needs to generate a communication beamforming vector (i.e., the uplink reception communication beamforming vector) with the assistance of fused sensing information. If the uplink reception communication beamforming vector has been generated, the first signal processing module 111 performs beam management with the assistance of fused sensing information. Please refer to the relevant description of Case 1 above for details.

Case 3, in the downlink preamble symbol time slot, the first signal processing module 111 performs downlink reception beamforming and management. In the downlink preamble symbol time slot, the first signal processing module 111 only receives the echo signal of the downlink pilot signal, and the first signal processing module 111 determines whether the downlink reception communication beamforming vector has been generated. If the downlink reception communication beamforming vector has not been generated, the first signal processing module 111 only needs to generate a communication beamforming vector (i.e. the downlink reception communication beamforming vector) with the assistance of fused sensing information. If the downlink reception communication beamforming vector has been generated, the first signal processing module 111 performs beam management with the assistance of fused sensing information. Please refer to the relevant description of Case 1 above for details.

Case 4, in the downlink data symbol time slot, the first signal processing module 111 performs downlink reception beamforming and management. In the downlink data symbol time slot, the first signal processing module 111 receives the echo signals of the downlink data signal and of the active detection signal, then the first signal processing module 111 determines whether the downlink reception communication beamforming vector and downlink reception sensing beamforming vector have been generated. If the downlink reception communication beamforming vector and downlink reception sensing beamforming vector have not been generated, the first signal processing module 111 generates a communication beamforming vector (i.e. the downlink reception communication beamforming vector) and a dedicated sensing beamforming vector (i.e. the downlink reception sensing beamforming vector) with the assistance of fused sensing information. If the downlink reception communication beamforming vector and downlink reception sensing beamforming vector have been generated, the first signal processing module 111 performs beam management with the assistance of fused sensing information. Please refer to the relevant description of Case 1 above for details.

In the embodiment of the present application, the second signal transmission module 121 and the second signal processing module 122 can also perform beamforming and management through the above method, which will not be repeated here.

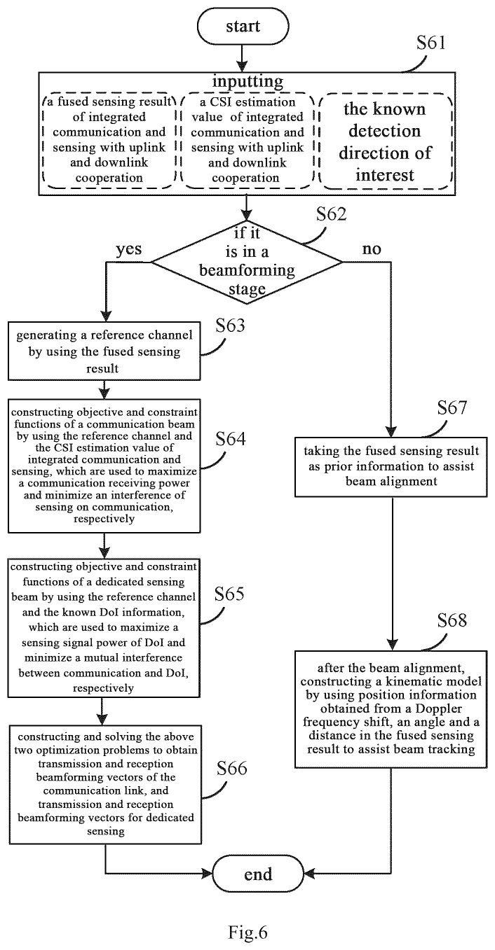

Referring to FIG. 6, which is a schematic diagram of a processing flow of a beamforming and management submodule provided by an embodiment of the present application.

Step S61, inputting a fused sensing result (i.e. fused sensing information) of integrated communication and sensing with uplink and downlink cooperation, a CSI estimation value (i.e., a fused CSI estimation value) of integrated communication and sensing with uplink and downlink cooperation, and a known detection direction of interest (i.e., DoI).

Step S62, determining whether it is a beamforming stage, and if so, carrying out Step S63; if not, carrying out Step S67.

Step S63, generating a reference channel by using the fused sensing result.

Step S64, constructing objective and constraint functions of a communication beam by using the reference channel and the CSI estimation value of integrated communication and sensing, which are used to maximize a communication receiving power and minimize an interference of sensing on communication, respectively.

Step S65, constructing objective and constraint functions of a dedicated sensing beam by using the reference channel and the known DoI information, which are used to maximize a sensing signal power of DoI and minimize a mutual interference between communication and DoI, respectively.

Step S66, constructing and solving the above two optimization problems to obtain transmission and reception beamforming vectors of the communication link, and transmission and reception beamforming vectors for dedicated sensing.

Step S67, taking the fused sensing result as prior information to assist in beam alignment.

Step S68, after the beam alignment, constructing a kinematic model by using position information obtained from a Doppler frequency shift, an angle (i.e. AOA), and a distance in the fused sensing result to assist beam tracking.

In the technical solution provided by the embodiment of the present application, the first signal processing module and the first signal transmission module take the fused sensing information that fuses the uplink and downlink sensing information, the fused CSI estimation value that fuses the uplink and downlink CSI estimation values, and the direction of interest as inputs, and use the above prior information to assist beamforming and beam management, thereby improving the ability to suppress mutual interference between communication and sensing, and further improving communication and sensing performance.

The following is a brief description of channels and signals involved in the embodiments of the present application.

In the embodiments of the present application, an uplink communication channel can refer to a frequency domain response H_{n,m}^{U} of an uplink communication channel on the n-th subcarrier of the m-th OFDM symbol shown in Formula (3).

$${H}_{n , m}^{U} = \text{?} [ \text{?} a ( \text{?} ) {a}^{T} ( \text{?} ) ] \qquad Formula ( 3 )$$

$$\text{?} \text{indicates text missing or illegible when filed}$$

wherein, l represents the number of the communication path, l=0 represents an amplitude and phase fading coefficient of the line of sight (LoS) path, l={1, . . . , L−1}represents an amplitude and phase fading coefficient of the l-th non line of sight (NLoS, Non line of sight) path, and L is the total number of paths; U in a superscript represents relevant parameters of the uplink communication channel, a(p_{RX,l}^{U}) and a^{T}(p_{TX,l}^{U}) represent receiving and transmitting antenna array guidance vectors, respectively, p_{RX,l}^{U} and p_{TX,l}^{U} represent an AoA (i.e., Angle of Arrival) and an AoD (i.e., Angle-of-departure) corresponding to the receiving and transmitting antenna array guidance vectors, f_{c,l} represent a Doppler frequency shift of the l-th path, τ_{c,l} is a delay of the l-th path, and a subscript c represents relevant parameters of the communication channel. bₗ represents an amplitude and phase response coefficient of the l-th path. Tₛ represents an OFDM symbol duration, Δf represents a subcarrier interval. j represents the complex unit, n represents pi, and e represents a natural base. The access device estimates the angle of arrival p_{RX,l}^{U}, the Doppler frequency shift f_{c,l}, and the delay τ_{c,l} in the uplink communication channel to obtain the AoA, the Doppler frequency shift, and the delay (i.e. distance) of the terminal and an environmental reflector. In the embodiment of the present application, the angle estimated by the incident angle estimation submodule is \hat{p}_{RX,l}^{U}.

The uplink pilot signal received by the access device can refer to the m-th OFDM uplink communication pilot reception symbol vector of the n-th subcarrier y̅_{n,m}^{U} shown in Formula (4).

$${\overline{y}}_{n , m}^{U} = \sqrt{{\overline{P}}_{U}} {\overline{d}}_{n , m}^{U} {H}_{n , m}^{U} ( {w}_{TX}^{U} ) + {\overline{n}}_{n , m}^{U} \qquad Formula ( 4 )$$

wherein, the U in the superscript and subscript represents a relevant parameter of the uplink communication channel, P̅_{U} represents an uplink pilot symbol transmission power of the terminal, \dot{d}_{n,m}^{U} represents an uplink pilot symbol at the position of the m-th OFDM symbol on the n-th subcarrier transmitted by the terminal, H_{n,m}^{U} represents a frequency domain response of the uplink communication channel on the n-th subcarrier of the m-th OFDM symbol, W_{TX}^{U} represents an uplink transmission beamforming vector of the terminal (i.e. the uplink transmission communication beamforming vector), n̅_{n,m}^{U} represents a white noise reception vector of the uplink preamble symbol time slot. The access device uses the array of received signals y̅_{n,m}^{U} and the known transmission symbol (i.e. the pilot symbol sent by the terminal) d̅_{n,m}^{U}, to estimate the angle of arrival p_{RX,l}^{U}, the Doppler frequency shift f_{c,l}, and the delay τ_{c,l} contained in H_{n,m}^{U}, in order to obtain angle sensing information, distance sensing information, and frequency shift sensing information.

The uplink data signal received by the access device can refer to the m-th OFDM uplink data communication receiving symbol vector of the n-th subcarrier y_{n,m}^{U} shown in Formula (5).

$${y}_{n , m}^{U} = \sqrt{{P}_{U}} {d}_{n , m}^{U} {H}_{n , m}^{U} ( {w}_{TX}^{U} ) + {n}_{n , m}^{U} \qquad Formula ( 5 )$$

wherein, the U in the superscript and subscript represents a relevant parameter of the uplink communication channel, P_{U} represents an uplink data symbol transmission power of the terminal, d_{n,m}^{U} represents a random data symbol at the position of the m-th OFDM symbol on the n-th subcarrier transmitted by the terminal, H_{n,m}^{U} represents a frequency domain response of the uplink communication channel on the n-th subcarrier of the m-th OFDM symbol, W_{TX}^{U} represents an uplink transmission beamforming vector of the terminal (i.e. the uplink transmission communication beamforming vector), n_{n,m}^{U} represents a white noise reception vector of the uplink preamble symbol time slot.

In the embodiment of the present application, due to the characteristics of channel reciprocity within coherent time, a frequency domain response of the downlink communication channel is a transposition of a frequency domain response of the uplink communication channel. The frequency domain response of the downlink communication channel on the n-th subcarrier of the m-th OFDM symbol is H_{n,m}^{U}=(H_{n,m}^{U})^{T}, wherein H_{n,m}^{U} represents the frequency domain response of the uplink communication channel on the n-th subcarrier of the m-th OFDM symbol, and the superscript D represents a relevant parameter of the downlink communication channel.

The downlink pilot signal received by the terminal can refer to the m-th OFDM downlink communication pilot reception symbol vector of the n-th subcarrier y̅_{n,m}^{D} shown in Formula (6).

$${\overline{y}}_{n , m}^{D} = \sqrt{{\overline{P}}_{D}} {{\overline{d}}_{n , m}^{D} ( {w}_{RX}^{D} )}^{H} {H}_{n , m}^{D} ( {w}_{TX}^{D} ) + {\overline{n}}_{n , m}^{D} \qquad Formula ( 6 )$$

wherein, the D in the superscript and subscript represent a relevant parameter of the downlink communication channel, P̅_{D} represents a downlink pilot symbol transmission power of the access device, d̅_{n,m}^{D} represents a downlink pilot symbol at the m-th OFDM symbol position of the n-th subcarrier transmitted by the access device, W_{RX}^{D} represents a downlink reception beamforming vector of the terminal (i.e. the downlink reception communication beamforming vector), there is w_{RX}^{D}=w_{TX}^{U}, w_{TX}^{U} represents an uplink transmission beamforming vector of the terminal, (*)^{H} represents performing conjugate transposition on the matrix in parentheses, w_{TX}^{D} represents a downlink transmission beamforming vector of the access device (i.e. the downlink transmission communication beamforming vector) generated by the beamforming and management submodule with the assistance of the fused sensing information. H_{n,m}^{D} represents a frequency domain response of the downlink communication channel on the n-th subcarrier of the m-th OFDM symbol, and n̅_{n,m}^{D} represents a Gaussian white noise after reception beamforming, which is the white noise reception vector of the downlink preamble time slot.

The downlink data signal received by the terminal can refer to the m-th OFDM downlink data communication reception symbol vector of the n-th subcarrier y_{C,n,m}^{D} shown in Formula (7).

$${y}_{C , n , m}^{D} = {( {w}_{RX}^{D} )}^{H} {H}_{n , m}^{D} ( \sqrt{{P}_{D}} {d}_{n , m}^{D} {w}_{TX}^{D} + \sqrt{{P}_{S}} {d}_{n , m}^{S} {w}_{TX}^{S} ) + {n}_{C , n , m}^{D} \qquad Formula ( 7 )$$

wherein, D in the superscript and subscript represents a relevant parameter of the downlink communication channel, and C in the subscript represents a relevant parameter of the communication channel. w_{RX}^{D} represents a downlink reception beamforming vector of the terminal, (*)^{H} represents performing conjugate transposition on the matrix in parentheses, H_{n,m}^{D} represents a frequency domain response of the downlink communication channel on the n-th subcarrier of the m-th OFDM symbol, P_{D} is a downlink data signal transmission power of the access device, d_{n,m}^{D} represents a random data symbol at the m-th OFDM symbol position of the n-th subcarrier transmitted by the access device, w_{TX}^{D} represents a downlink transmission beamforming vector of the access device in the direction of the terminal (i.e. the downlink transmission communication beamforming vector), and the superscript and subscript S represent relevant parameters of the downlink sensing channel, P_{S} represents a transmission power of the sensing symbol (i.e. the active detection signal symbol), and d_{n,m}^{S} represents a dedicated sensing transmission symbol, w_{TX}^{S} represents a dedicated sensing beamforming vector of the access device in the DoI direction (i.e. the downlink transmission sensing beamforming vector), and w_{C,n,m}^{D} represents the white noise reception vector of the downlink data symbol time slot. In the embodiment of the present application, \sqrt{P_{S}}d_{n,m}^{S}(w_{TX}^{D})^{H}H_{n,m}^{D} w_{TX}^{S} is the interference that a dedicated sensing beam signal (i.e. an active detection signal) may cause to communication.

In the embodiment of the present application, the echo signals of the downlink pilot signal, the downlink data signal, and the active detection signal pass through the echo sensing channel, and the downlink single base echo sensing channel H_{S,n,m} of the n-th subcarrier of the m-th OFDM symbol is as shown in Formula (8).

$$\text{?} = {\sum }_{k = 0}^{K - 1} [ \text{?} a ( {p}_{RX , k}^{S} ) {a}^{T} ( {p}_{TX , k}^{S} ) ] \qquad Formula ( 8 )$$

$$\text{?} \text{indicates text missing or illegible when filed}$$

wherein, K represents the number of targets (including a terminal, an environmental reflector in the direction of the terminal, and a potential environmental reflector in the direction of interest), k represents an index of the target, S in the superscript and subscript represents a parameter related to the single base echo sensing, b_{S,k} is an amplitude and phase reflection coefficient of the k-th target, f_{S,k} is a Doppler frequency shift of the k-th target, and τ_{S,k} is a round-trip delay of the k-th target. a(p_{RX,k}^{S}) and a^{T}(p_{TX,k}^{S}) represent receiving and transmitting antenna array guidance vectors of the k-th target, respectively. p_{RX,k}^{S} and p_{TX,k}^{S} represent an angle of arrival and a transmission angle corresponding to the receiving and transmitting antenna array guidance vectors of the k-th target, respectively. For the sensing of single base active way, there is p_{RX,k}^{S}=p_{TX,k}^{S}. Tₛ represents an OFDM symbol duration, Δf represents a subcarrier interval. j represents the complex unit, n represents pi, and e represents a natural base. The access device estimates the angle of arrival p_{RX,k}^{S}, the Doppler frequency shift f_{S,k}, and the delay τ_{S,k} in the downlink single base echo sensing channel to obtain the AoA, Doppler frequency shift, and delay (i.e. distance) of the target. In the embodiment of the present application, the angle estimated by the incident angle estimation submodule is \hat{p}_{RX,k}^{S}.

In the downlink data symbol time slot, the echo signal received by the access device refers to the echo reception signal of the m-th OFDM downlink integrated communication and sensing signal of the n-th subcarrier y_{S,n,m}^{D} shown in Formula (9).

$${y}_{S , n , m}^{D} = {H}_{S , n , m} ( \sqrt{{P}_{D}} {d}_{n , m}^{D} {w}_{TX}^{D} + \sqrt{{P}_{S}} {d}_{n , m}^{S} {w}_{TX}^{S} ) + {n}_{S , n , m} \qquad Formula ( 9 )$$

wherein, D in the superscript and subscript represents a relevant parameter of the downlink communication channel, S in the superscript and subscript represents the parameter related to single base echo sensing, and H_{S,n,m} represents the downlink single base echo sensing channel of the n-th subcarrier of the m-th OFDM symbol, P_{D} is a downlink data signal transmission power of the access device, d_{n,m}^{D} represents a random data symbol at the m-th OFDM symbol position of the n-th subcarrier transmitted by the access device, w_{TX}^{D} represents a downlink transmission beamforming vector of the access device in the direction of the terminal, P_{S} represents a transmission power of the sensing symbol (i.e. the active detection signal symbol), and d_{n,m}^{S} represents a dedicated sensing transmission symbol, w_{TX}^{S} represents the dedicated sensing beamforming vector of the access device in the DoI direction (i.e., the downlink transmission sensing beamforming vector), and n_{S,n,m} represents the white noise vector received by the array, i.e., the white noise reception vector of the downlink data symbol time slot. The downlink integrated communication and sensing requires the use of receiving symbol y_{S,n,m}^{D} to estimate the time delay (i.e., distance) and Doppler frequency shift of the target (such as a terminal and an environmental reflector) in the AoA direction of the terminal and in the DoI direction contained in the H_{S,n,m}.

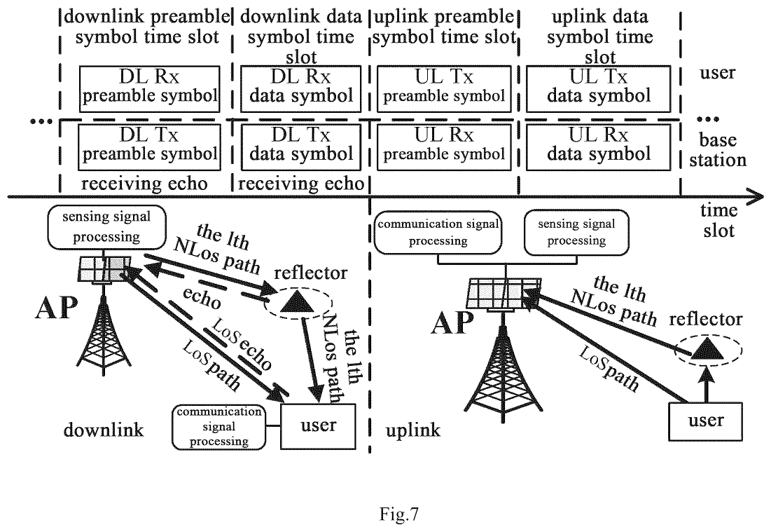

The following describes in detail a signal processing system for integrated communication and sensing provided by the embodiments of the present application in combination with FIG. 7 to FIG. 12. The terminal is taken as user equipment (hereinafter referred to as user) and the access device is taken as a base station or an AP as an example for explanation, which is not limited.

FIG. 7 is a schematic diagram of a scenario where two-way integrated communication and sensing between transmission and reception provided by an embodiment of the present application. Wherein, UL (uplink) represents an uplink, DL (downlink) represents a downlink, Tx represents a transmitted signal, and Rx represents a received signal.

In continuous downlink and uplink time slots, the AP alternates and the user perform downlink and uplink integrated communication and sensing operations alternately. Both AP and users use an array antenna. The user carries an array antenna that changes transmission and reception status as the uplink and downlink communication time slots change. The AP carries two array antennas with good spatial isolation, which can achieve the ability to transmit and receive signals simultaneously.

In the uplink preamble symbol time slot, the user transmits an uplink pilot signal (i.e. UL TX preamble symbol) specified by a protocol standard, and the AP receives an uplink pilot signal (i.e. UL RX preamble symbol) to perform synchronization, channel estimation, and other communication control signaling operations, while estimating the user's AoA, distance and radial relative motion speed based on the dual-base sensing method. In the uplink data symbol time slot, the user transmits an uplink data signal (i.e. UL TX data symbol), and the AP receives and demodulates the uplink data signal (i.e. UL RX data symbol). In the downlink preamble symbol and downlink data symbol time slots, both pilot sequences and data frames can be used for integrated communication and sensing.

In the uplink time slot, the uplink signal transmitted by the user directly reaches the AP through LoS, and reaches the AP through the reflector passing through the l-th NLoS (l={1, . . . , L−1}). The AP uses two array antennas to receive the uplink signal, and simultaneously performs communication signal processing and sensing signal processing.

In the downlink preamble time slot, the AP transmits a downlink pilot signal (i.e. DL TX preamble symbol) to the user, and the user receives a downlink pilot signal (i.e. DL RX preamble) to perform synchronization, channel estimation, and other communication control signaling operations. The AP can receive echoes from potential targets (such as environmental reflectors) in the direction of the user for single base active sensing. In the downlink data symbol time slot, the AP transmits the downlink data signal (i.e. DL TX data symbol) to the user, and the user receives and demodulates the downlink data signal (i.e. DL RX data symbol). Meanwhile, the AP can transmits an active sensing signal (i.e. an active detection signal) in the direction of interest; the AP receives echo signals in the direction of the user and the direction of interest for single basis active sensing, estimates the sensing information of potential targets in the direction of the user and the direction of interest.

In the downlink time slot, the downlink signal transmitted by the AP directly reaches the user through LoS, and reaches the user through the reflector passing through the l-th NLoS (l={1, . . . , L−1}). The user receives downlink signals from multiple paths and performs downlink communication signal processing. The AP uses one array antenna for transmitting downlink signal, and another array antenna for receiving the echo signal for sensing signal processing.

According to the above process description, the AP senses the same physical environment in continuously alternating uplink and downlink time slots. However, in an extremely short time slot, the position and velocity of targets in the physical environment remain almost unchanged, which also makes the time-division duplex system have channel reciprocity. Therefore, the sensing information obtained from the integrated communication and sensing in continuous uplink and downlink time slots can be regarded as independent estimates of the same target, and AP can fuse the sensing results of the uplink and downlink integrated communication and sensing to improve environmental sensing ability; on the other hand, due to the channel reciprocity of TDD systems, the uplink and downlink channel state information matrices are transposed. Therefore, the reciprocity of TDD systems can also be used to fuse CSI estimation values to improve the accuracy of channel estimation and thus improve communication reliability.

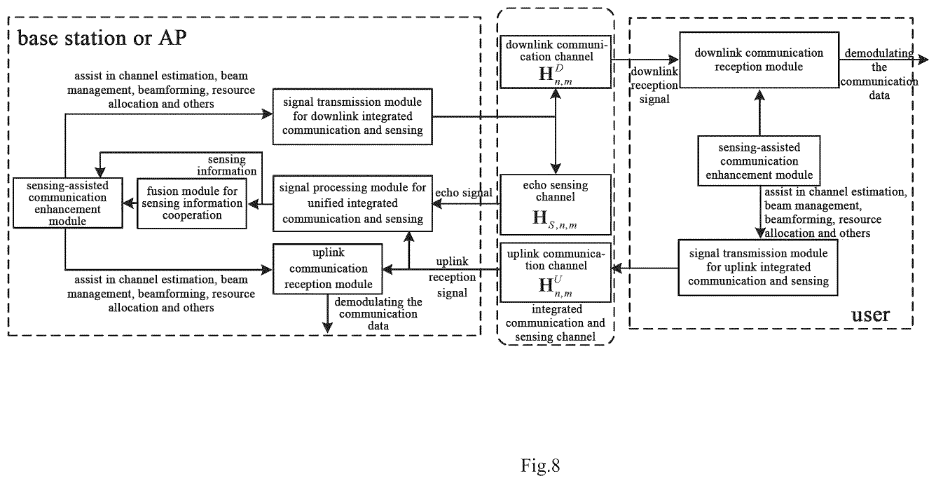

FIG. 8 is a fourth structure schematic diagram of the signal processing system for integrated communication and sensing provided by an embodiment of the present application.

In a continuous process of the uplink and downlink integrated communication and sensing, the base station or AP uses a signal processing module for unified integrated communication and sensing (i.e. a first signal processing module) to process echo signals of downlink integrated communication and sensing (including echo signals of a downlink signal and active detection signals passing through an echo sensing channel) and an uplink integrated communication and sensing direct signal (i.e. an uplink signal) to obtain sensing information. The sensing information cooperation fusion module (i.e. a sensing fusion module) performs data fusion on sensing information obtained from the uplink and downlink integrated communication and sensing to obtain environmental sensing information (i.e. fused sensing information) with higher accuracy and larger range. A sensing-assisted communication enhancement module uses the above sensing information (i.e. the sensing information obtained by the unified integrated communication and sensing signal processing module and the sensing information obtained by the sensing information cooperation fusion module) as prior information to assist in channel estimation, beam management, beamforming, resource allocation and other detection estimation and optimization steps. With the assistance of the sensing-assisted communication enhancement module, an uplink communication reception module (including a first channel estimation module, a first communication demodulation module, etc.) receives an uplink reception signal passing through the uplink communication channel and demodulates communication data. A downlink integrated communication and sensing signal transmission module (i.e. a first signal transmission module), with the assistance of the sensing-assisted communication enhancement module, transmits a downlink signal to the user. The user receives a downlink reception signal passing through the downlink communication channel through a downlink communication reception module (i.e. a second signal processing module), and demodulates the communication data with the assistance of the sensing-assisted communication enhancement module. In the uplink time slot, the sensing-assisted communication enhancement module uses the sensing information feedback from the base station as prior information to assist in channel estimation, beam management, beamforming, resource allocation and other detection estimation and optimization steps. With the assistance of the sensing-assisted communication enhancement module, the user sends an uplink signal to the base station or AP through an uplink integrated communication and sensing signal transmission module (i.e. a second signal transmission module).

The signal processing system for integrated communication and sensing with uplink and downlink cooperation, as shown in FIG. 8, achieves cooperation fusion enhancement of sensing information of the uplink and downlink integrated communication and sensing, and uses the enhanced sensing information to provide prior information for detection estimation and optimization steps such as performing channel estimation, beam management, beamforming, and resource allocation in the process of the uplink and downlink integrated communication and sensing, thereby enhancing the optimization configuration of resources, beams, and other resources for a next cycle of the uplink and downlink integrated communication and sensing, and achieving iterative improvement in the performance of integrated communication and sensing.

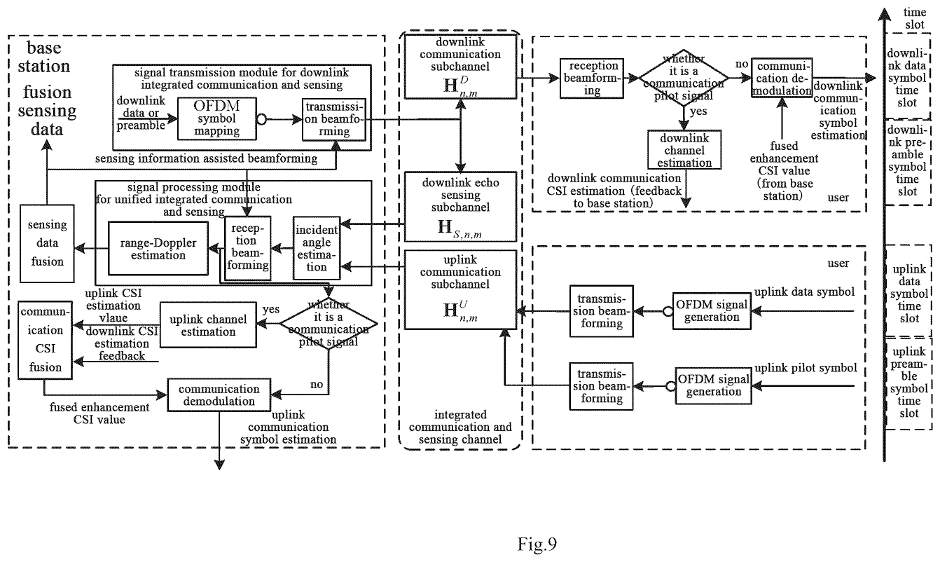

FIG. 9 is a fifth structure schematic diagram of the signal processing system for integrated communication and sensing provided by an embodiment of the present application. The signal processing system for integrated communication and sensing is further referred to as an integrated communication and sensing system with uplink and downlink cooperation.

The integrated communication and sensing system with uplink and downlink cooperation includes general functional modules: an incident angle estimation module (i.e., an incident angle estimation submodule), a range-Doppler estimation module (i.e., a range-Doppler frequency shift estimation submodule), a channel estimation module (including an uplink channel estimation module and a downlink channel estimation module, i.e., a first channel estimation module and a second channel estimation module), a communication demodulation module (i.e., a first communication demodulation module and a second communication demodulation module); and functional modules: a sensing data fusion module based on integrated communication and sensing with uplink and downlink cooperation (i.e., a sensing fusion module), a communication CSI fusion module based on uplink and downlink cooperation (i.e., a CSI fusion module), and a sensing information assisted beamforming and beam management module based on uplink and downlink cooperation (including a reception beamforming module and transmission beamforming module, i.e., a beamforming and management submodule). The signal processing system for integrated communication and sensing also includes an OFDM symbol mapping module and an OFDM signal generation module (i.e., an OFDM signal generation submodule). The incident angle estimation module, the reception beamforming module, and the range-Doppler estimation module on the base station side form a unified integrated communication and sensing signal processing module (i.e., the first signal processing module), and the OFDM symbol mapping module and the transmitting beamforming module form a downlink integrated communication and sensing signal transmission module (i.e., the first signal transmission module). The integrated communication and sensing channel between the base station and the user includes an uplink communication sub-channel (i.e., an uplink communication channel), a downlink communication sub-channel (i.e., an uplink communication channel), and a downlink echo sensing sub-channel (i.e., an echo sensing channel).

The signal processing process of the integrated communication and sensing system with uplink and downlink cooperation is as follows. One signal processing process of the integrated communication and sensing system with uplink and downlink cooperation includes four time slots: an uplink preamble symbol time slot, an uplink data symbol time slot, a downlink preamble symbol time slot, and a downlink data symbol time slot. In the uplink preamble symbol time slot, the user processes the uplink pilot symbol through the OFDM signal generation module and the transmission beamforming module, and transmits the pilot signal (i.e. the uplink pilot signal). Through the uplink communication sub-channel, after receiving the array of received signals of the pilot signal, the base station performs incident angle estimation by using the incident angle estimation module. With the assistance of enhanced sensing information obtained by the sensing data fusion module of the integrated communication and sensing system with uplink and downlink cooperation (i.e., fused sensing information, including an angle, range and Doppler frequency shift of a user and an environmental reflector), beamforming is performed, and the reception beamforming module is used to generate a reception beamforming vector (i.e., an uplink reception communication beamforming vector) for baseband spatial filtering, and to determine whether the current signal is a communication pilot signal. If so, uplink channel estimation is performed on the baseband spatially filtered signal to obtain an uplink CSI estimation value, and the uplink CSI estimation value is input into the communication CSI fusion module. The communication CSI fusion module fuses the uplink CSI estimation value and the obtained downlink CSI estimation feedback (i.e., the downlink CSI estimation value). Meanwhile, with the assistance of enhanced sensing information, the integrated communication and sensing method based on dual-base sensing is used to estimate the range and Doppler frequency shift of users and strong reflectors in the environment. The above sensing information (i.e. the first sensing information) such as the angle, range and Doppler frequency shift are input into the sensing data fusion module, and is fused with the sensing data (i.e. the second sensing information) obtained through downlink integrated communication and sensing to enhance the sensing accuracy and detection rate of environmental targets.

In the uplink data symbol time slot, the user transmits an uplink data signal carrying random data symbols (i.e. uplink data symbols) through the OFDM signal generation module and the transmission beamforming module. Through the uplink communication sub-channel, the base station array, after receiving the uplink data signal, performs incident angle estimation through the incident angle estimation module, generates a reception beamforming vector through the reception beamforming module for baseband spatial filtering, and determines whether the current signal is a communication pilot signal. If not, the baseband spatially filtered signal is transmitted to the communication demodulation module. The communication demodulation module uses the fused enhancement CSI estimation value (i.e., fused CSI estimation value) obtained by the communication CSI fusion module of the integrated communication and sensing system with uplink and downlink cooperation to perform uplink communication symbol estimation, and demodulate and decode the filtered uplink data signal.

In the downlink preamble symbol time slot, the base station uses the OFDM symbol mapping module and the transmission beamforming module to process the downlink data or preamble and transmit the pilot signal (i.e., the downlink pilot signal) to the user. Due to the channel reciprocity of TDD systems, the base station and user can perform the transmission and reception of the downlink communication signals (i.e. downlink pilot signals and downlink data signals) using the same antenna weight vector as the uplink reception beamforming vector (i.e. uplink reception communication beamforming vector) and the uplink transmission beamforming vector (i.e. uplink transmission communication beamforming vector), respectively. The user receives the pilot signal (i.e. downlink pilot signal) through the downlink communication sub-channel, performs beamforming through the reception beamforming module, and determines whether the current signal is a communication pilot signal. If so, the downlink channel is estimated using the pilot signal after reception beamforming, and the downlink communication CSI estimation result (i.e., downlink CSI estimation value) is fed back to the base station. At the same time, an environmental reflector within the beam range in the user direction will reflect the pilot signal. After the reception array of the base station receives the echo signal of the pilot signal, it estimates the incident angle, range and Doppler frequency shift of the reflector in the user direction. The above sensing information of angle, range and Doppler frequency shift are input into the sensing data fusion module, and is fused with the sensing data (i.e., the first sensing information) of the uplink integrated communication and sensing to enhance the sensing accuracy and detection rate of environmental targets (such as users and environmental reflectors).

In the downlink data symbol time slot, the base station uses a beamforming vector of a communication link established by the downlink preamble symbol time slot (i.e. the downlink transmission communication beamforming vector) to transmit a downlink data signal to the user direction; at the same time, the base station transmits an active detection beam signal (i.e., an active detection signal) to the DoI direction to detect targets in the direction of interest. The transmission beamforming module, with the assistance of enhanced sensing information obtained by the sensing data fusion module, ensures that the active detection beam signal does not interfere with the reception and demodulation of the downlink data signal, and maximizes the power gain of the active detection beam. The user demodulates the downlink data signal through the communication demodulation module by using the integration enhanced CSI estimation value obtained by the communication CSI fusion module of the integrated communication and sensing system with uplink and downlink cooperation (i.e. using the fused CSI estimation value feedback from the base station). At the same time, a reflector in the user direction and a potential reflector in the DoI direction generate echo signals, which are received by the reception array of the base station. With the assistance of enhanced sensing information obtained from the sensing data fusion module, the reception beamforming module is used to minimize the mutual interference of reflected echo signals in the user direction and DoI direction, thus achieving spatial filtering and separation reception of echo signals. Then, the base station estimates the range and Doppler frequency shift of the potential targets contained in the separated signals in the two directions mentioned above. The above sensing information of angle, range and Doppler frequency shift are input into the sensing data fusion module, and is fused with the sensing data of the uplink integrated communication and sensing to enhance the sensing accuracy and detection rate of environmental targets.

In the technical solution provided by the embodiments of the present application, the sensing data fusion module of integrated communication and sensing based on uplink and downlink cooperation matches and fuses the sensing results of the same target in the sensing results of uplink and downlink integrated communication and sensing, and outputs a sensing result with higher accuracy. The communication CSI fusion module based on uplink and downlink cooperation uses the channel reciprocity of time-division duplex systems to perform data fusion on the CSI estimation results of uplink and downlink channels, which obtains a communication estimation result with higher accuracy. The above performance improvement in the category of sensing information only requires a small increase in computing resources. The sensing information assisted beamforming and beam management module based on uplink and downlink cooperation uses the above fused sensing results and channel estimation information as prior information to assist in enhancing beamforming and beam management performance. The whole process does not need the assistance of other sensors, and only needs the sensing information obtained by the network itself, which greatly improves the energy utilization efficiency of the system. Through the enhanced sensing information obtained from uplink and downlink cooperation and the fused enhanced CSI value, the uplink and downlink cooperation gain is achieved, and the communication and sensing performance is improved.

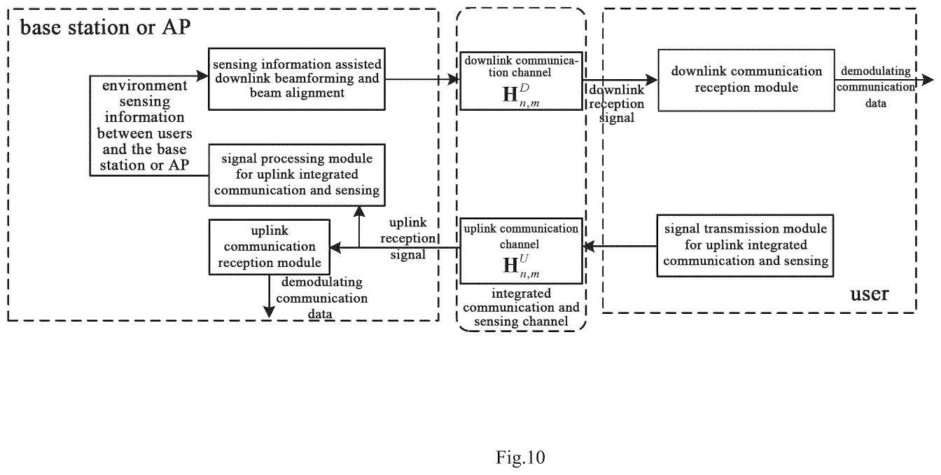

FIG. 10 is a sixth structure schematic diagram of the signal processing system for integrated communication and sensing provided by an embodiment of the present application. The integrated communication and sensing channel includes an uplink communication channel and a downlink communication channel.

In the embodiment of the present application, sensing information of the uplink integrated communication and sensing (i.e. first sensing information) assists in downlink beamforming and beam alignment. The user transmits an uplink signal through a signal transmission module (i.e. a second signal transmission module) for uplink integrated communication and sensing. The base station or AP receives an uplink reception signal (i.e. an uplink signal passing through the uplink communication channel), performs sensing estimation for uplink integrated communication and sensing through a signal processing module (i.e., a first signal processing module) for uplink integrated communication and sensing, to obtain an angle, range and Doppler frequency shift and other environmental sensing information of the targets (such as a user and an environmental reflector) in the environment between the user and the base station or AP, uses the sensing information as priori information to assist in downlink beamforming and beam alignment, and sends a downlink signal to the user, thereby enhancing the downlink communication performance.

In addition, a downlink communication reception module (including a second signal processing module, a second channel estimation module, and a second communication demodulation module) receives a downlink reception signal (i.e. a downlink signal passing through the downlink communication channel). The downlink communication reception module and an uplink communication reception module (including a first channel estimation module, a first communication demodulation module, etc.) demodulate the communication data respectively.

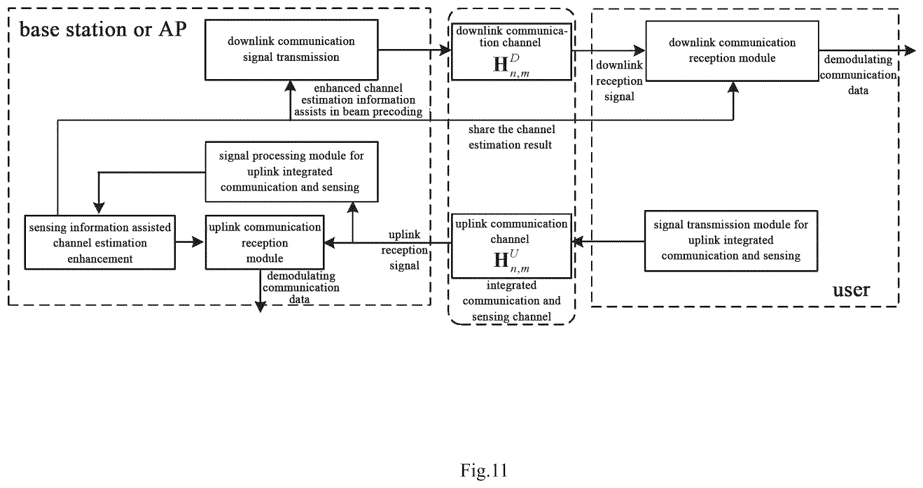

FIG. 11 is a seventh structure diagram of the signal processing system for integrated communication and sensing provided by an embodiment of the present application. The integrated communication and sensing channel includes an uplink communication channel and a downlink communication channel.

In the embodiment of the present application, the channel estimation is enhanced with the assistance of sensing information (i.e. first sensing information) of uplink integrated communication and sensing, and the enhanced channel estimation information assists in beam precoding and beamforming. The user transmits an uplink signal through a signal transmission module (i.e. a second signal transmission module) for uplink integrated communication and sensing. The base station or AP receives an uplink reception signal (i.e., an uplink signal passing through the uplink communication channel), performs sensing estimation for uplink integrated communication and sensing through a signal processing module (i.e., a first signal processing module) of the uplink integrated communication and sensing to obtain an angle, range and Doppler frequency shift and other environmental sensing information of the targets (such as the user and environmental reflector) in the environment between the user and the base station or AP. Since the environmental sensing information are strongly correlated with a channel state matrix, a channel estimation enhancement module assisted by the sensing information can be used to enhance the accuracy of channel estimation through adaptive filtering, machine learning and other methods, thereby improving the reliability of uplink communication. In addition, the enhanced channel estimation information can assist in beam precoding, thereby improving communication performance such as a signal-to-noise ratio and reliability in downlink communication.

In addition, an uplink communication reception module (including a first channel estimation module, a first communication demodulation module, etc.) demodulates communication data with the assistance of the channel estimation enhancement module assisted by the sensing information. In the downlink time slot, a downlink communication reception module (including a second signal processing module, a second channel estimation module, and a second communication demodulation module) receives a downlink reception signal (i.e., a downlink signal passing through the downlink communication channel), and demodulates the communication data with the assistance of a channel estimation result shared by the base station.

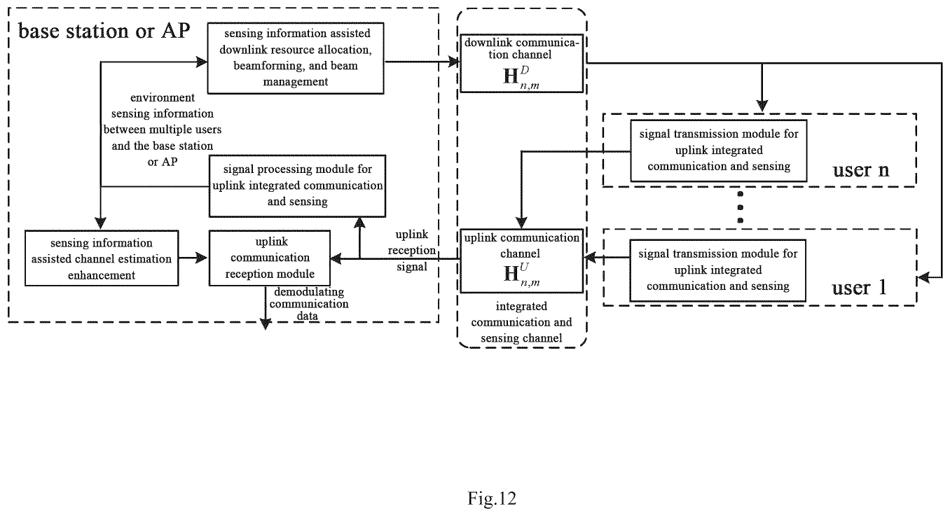

FIG. 12 is an eighth structure schematic diagram of the signal processing system for integrated communication and sensing provided by an embodiment of the present application. The integrated communication and sensing channel includes an uplink communication channel and a downlink communication channel. The number of users in the figure is only an example and does not have a limiting effect.

In the embodiment of the present application, in the case of multiple users, sensing information of uplink integrated communication and sensing (i.e. first sensing information) assists in downlink communication enhancement. Considering that in the case of multiple users, the multiple users (such as user 1 to user n) transmit orthogonal integrated communication and sensing signals (i.e. uplink signals) to the base station through a signal transmission module (i.e. a second signal transmission module) of uplink integrated communication and sensing. The base station receives uplink reception signals (i.e. uplink signals through the uplink communication channel) from the multiple users, and performs sensing estimation for uplink integrated communication and sensing through a signal processing module (i.e. a first signal processing module) of uplink integrated communication and sensing, to obtain environmental sensing information between the multiple users and the base station or AP, for example, information such as an angle, range and Doppler frequency shift of the multiple users and environmental reflectors. The channel estimation enhancement module assisted by the sensing information can be used to assist in enhancing the accuracy of channel estimation for the multiple users by using the sensing information. At the same time, multi-user location information (i.e. sensing information) can be used to assist in enhancing downlink resource allocation, beamforming, and beam management. Downlink signals are sent to the multiple users through downlink communication channels, suppressing the interference between the multiple users and improving the downlink communication performance of the multiple users. In addition, an uplink communication reception module (including a first channel estimation module, a first communication demodulation module, etc.) demodulates communication data with the assistance of a channel estimation enhancement module assisted by sensing information.

The integrated communication and sensing system with uplink and downlink cooperation shown in FIG. 10 to FIG. 12 above is small in scale but includes a core architecture of the integrated communication and sensing system with uplink and downlink cooperation, covering a lightweight uplink and downlink cooperation integrated communication and sensing system framework in various scenarios, from single user to multiple users.

In the technical solution provided by embodiments of the present application, within the coherent time, some of the sensing estimation results obtained from integrated communication and sensing with uplink and downlink cooperation are sensing of the same environmental target. The present application makes use of this feature to propose an integrated communication and sensing system with uplink and downlink cooperation, thereby achieving data fusion of sensing results and communication channel estimation results in the process of uplink and downlink integrated communication and sensing, respectively improving sensing accuracy and communication reliability; meanwhile, the channel information is reconstructed using the sensing results to achieve beamforming of the uplink and downlink cooperation, reducing communication sensing mutual interference, and improving communication and sensing performance.

The present application relates to signal processing for integrated communication and sensing in the field of wireless access networks. A signal processing and information fusion system for integrated communication and sensing with two-way cooperation between transmitter and receiver is specially proposed. By using the characteristics of alternating time slots in communication systems and the channel reciprocity of time-division duplex systems, the two-way integrated communication and sensing process provides sensing information as prior information to each other, thereby improving the communication and sensing performance of the integrated communication and sensing system. The signal processing system for integrated communication and sensing provided by this present application is suitable for network applications that require wireless intelligent machines, such as 6G (6th generation mobile networks, 6th generation mobile communication technology) based intelligent vehicle networking, drone networks, smart city monitoring, intelligent manufacturing, Wi-Fi based smart homes, and even drones and intelligent vehicle self-organizing network applications

In the technical solution provided by the embodiment of the present application, due to the fact that the position and velocity of an environmental reflector can be considered unchanged in an extremely short continuous transmission and reception time slot, the TDD system has the characteristic of channel reciprocity. Based on this characteristic, the sensing information and channel estimation information obtained from the integrated communication and sensing in continuous transmission and reception time slots have a potential for data fusion to improve the accuracy of sensing and channel estimation. Moreover, due to the almost unchanged channel state in continuous transmission and reception time slots, the sensing information obtained from the integrated communication and sensing process within continuous transmission and reception time slots can provide prior information for both receiver and transmitter to further improve the performance and timeliness of communication optimization processes such as a beamforming and beam management. However, the traditional integrated communication and sensing signal processing method that separates the design of the transmission and reception process has failed to take advantage of these potential gains. Therefore, the present application breaks through the traditional design of a signal processing system and method for integrated communication and sensing that separates the transmission and reception process, and further studies the integrated communication and sensing method of two-way cooperation between transmission and reception.

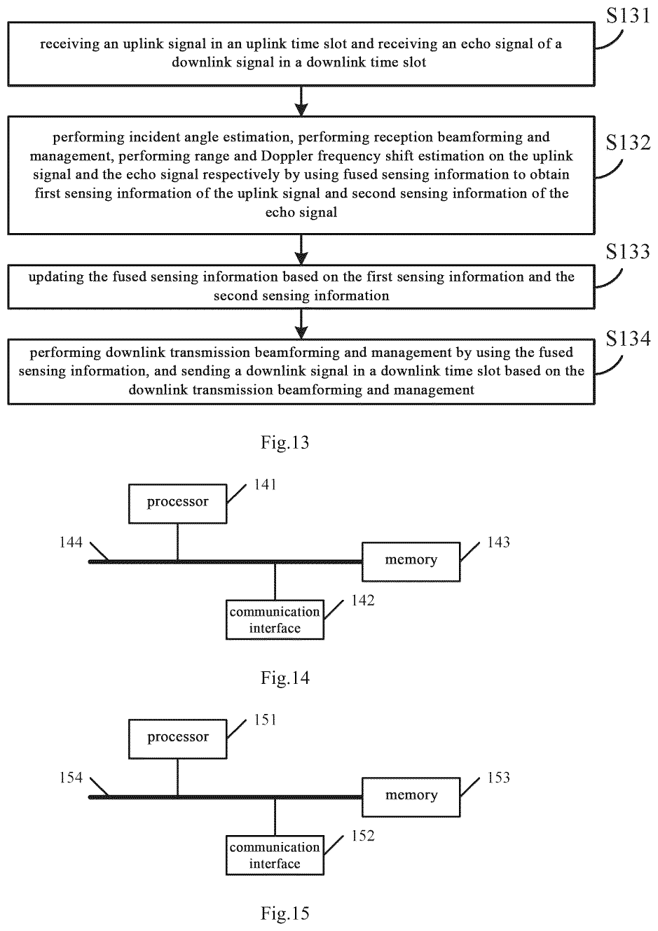

Corresponding to the signal processing system for integrated communication and sensing mentioned above, an embodiment of the present application further provides a signal processing method for integrated communication and sensing, as shown in FIG. 13, which is a flowchart of the signal processing method for integrated communication and sensing provided by the present embodiment, which is applied to an access device, the method includes the following steps.

Step S131, receiving an uplink signal in an uplink time slot and receiving an echo signal of a downlink signal in a downlink time slot.

Step S132, performing incident angle estimation, performing reception beamforming and management, performing range and Doppler frequency shift estimation on the uplink signal and the echo signal respectively by using fused sensing information to obtain first sensing information of the uplink signal and second sensing information of the echo signal.

Step S133, updating the fused sensing information based on the first sensing information and the second sensing information.

Step S134, performing downlink transmission beamforming and management by using the fused sensing information, and sending a downlink signal in a downlink time slot based on the downlink transmission beamforming and management.

Please refer to the relevant description of the signal processing system for integrated communication and sensing mentioned above for details.

In the technical solution provided by the embodiment of the present application, the access device, with the assistance of the obtained fused sensing information, performs incident angle estimation, reception beamforming and management, and range and Doppler frequency shift estimation on the received uplink signal and the received echo signal, to obtain new sensing information, i.e., first sensing information and second sensing information. The access device updates the fused sensing information based on the newly obtained sensing information, in order to obtain fused sensing information with higher accuracy, and with the assistance of higher accuracy fused sensing information, transmits a downlink signal. Since the access device and the terminal communicate in extremely short continuous transmission and reception time slots, the state of each target (such as a terminal and an environmental reflector) in the environment remain basically unchanged. Therefore, the obtained fused sensing information can be used to process the received signals, so as to improve the accuracy of signal processing. In addition, new sensing information can be obtained through the received signals to update the fused sensing information, so as to improve the accuracy of fused sensing information. Furthermore, by using the updated fused sensing information to assist in downlink signal transmission, the integrated communication and sensing in the two-way communication process is achieved, the environmental sensing ability and the performance of the communication optimization process are further improved.

In some embodiments, the uplink signal includes an uplink pilot signal and an uplink data signal, the method mentioned above further includes:
performing, after receiving the uplink pilot signal, channel estimation on the uplink pilot signal to obtain an uplink CSI estimation value; updating a fused CSI estimation value based on the uplink CSI estimation value and a downlink CSI estimation value; demodulating, after receiving the uplink data signal, the uplink data signal by using the fused CSI estimation value.

Please refer to the relevant description of the signal processing system for integrated communication and sensing mentioned above for details.

In the technical solution provided by the embodiments of the present application, due to the channel reciprocity of the TDD system within coherent time, the uplink and downlink CSI estimation values can be fused to obtain a fused CSI estimation value. The fused CSI estimation value can be used for communication demodulation to improve the accuracy of channel estimation and thereby improve the communication reliability.

In some embodiments, updating the fused CSI estimation value based on the uplink CSI estimation value and downlink CSI estimation value may include: estimating error values corresponding to the uplink CSI estimation value and the downlink CSI estimation value by using a matrix of received signals; fusing the uplink CSI estimation value and the downlink CSI estimation value by using the obtained error values, to obtain the fused CSI estimation value.

Please refer to the relevant description of the signal processing system for integrated communication and sensing mentioned above for details.

In the technical solution provided by the embodiment of the present application, the obtained uplink and downlink CSI estimation values and the matrix of received signals for channel estimation are taken as inputs, data fusion is performed on CSI of the uplink and downlink communication channels by using channel reciprocity to obtain a fused CSI estimation value with higher accuracy, as an output, thereby improving communication reliability.

In some embodiments, the downlink signal includes a downlink pilot signal, a downlink data signal, and an active detection signal; sending a downlink signal in a downlink time slot may include sending the downlink pilot signal and downlink data signal in a direction of the terminal in a downlink time slot, and sending the active detection signal in a direction of interest in the downlink time slot;
receiving an echo signal of the downlink signal in the downlink time slot may include: receiving an echo signal of the downlink pilot signal, an echo signal of the downlink data signal, and an echo signal of the active detection signal in the downlink time slot.

Please refer to the relevant description of the signal processing system for integrated communication and sensing mentioned above for details.

In the technical solution provided by the embodiment of the present application, sending an active detection signal in the direction of interest while sending a downlink signal in the direction of the terminal, so that the access device can detect other directions of interest through the active detection signal, to obtain sensing information of potential environmental reflectors in the environment, thereby enhancing the sensing accuracy and detection rate of targets in the environment.

In some embodiments, the first sensing information and the second sensing information include sensing information corresponding to multiple targets; updating the fused sensing information based on the first sensing information and the second sensing information may include:
estimating a signal-to-noise ratio of each target for sensing by using the matrix of received signals; estimating an error value of the sensing information corresponding to each target by using the signal-to-noise ratio of each target for sensing; and fusing the sensing information corresponding to each target by using the error value corresponding to each target to obtain the fused sensing information.

Please refer to the relevant description of the signal processing system for integrated communication and sensing mentioned above for details.

In the technical solution provided by the embodiment of the present application, the obtained uplink and downlink sensing information and the matrix of received signals for sensing estimation are taken as inputs, the sensing results of the same target in the uplink and downlink sensing information are matched and fused. Finally, the unmatched sensing results and the matched fused sensing results are output as a union to obtain fused sensing information with higher accuracy, which is used to assist in enhancing communication performance and prior information for application decision.

In some embodiments, the reception beamforming and management is performed by the following manners: performing reception beamforming and management by using the fused sensing information and the fused CSI estimation value;
performing downlink transmission beamforming and management by using the fused sensing information includes performing downlink transmission beamforming and management by using the fused sensing information and the fused CSI estimation value.

Please refer to the relevant description of the signal processing system for integrated communication and sensing mentioned above for details.

In the technical solution provided by the embodiment of the present application, the beamforming and management are performed by using the fused sensing information and the fused CSI estimation value with higher accuracy, thereby further improving sensing performance and enhancing communication performance such as a signal-to-noise ratio and reliability of uplink and downlink communication.

In some embodiments, performing reception beamforming and management by using the fused sensing information and the fused CSI estimation value may include: determining whether it is in a beamforming stage; if so, generating a reference channel by using the fused sensing information; generating a first function by using the reference channel and the fused CSI estimation value, and generating a second function by using the reference channel and information about a direction of interest, wherein the first function comprises objective and constraint functions of a communication beam, and the second function comprises objective and constraint functions of a dedicated sensing beam; and solving the first function and second function to obtain a communication beamforming vector and a dedicated sensing beamforming vector; if not, assisting in beam alignment by using the fused sensing information; after the beam alignment, assisting in beam tracking by using the fused sensing information.

Performing downlink transmission beamforming and management by using the fused sensing information and the fused CSI estimation value may include: determining whether it is in a beamforming stage; if so, generating a reference channel by using the fused sensing information; generating a first function by using the reference channel and the fused CSI estimation value, and generating a second function by using the reference channel and information about a direction of interest, wherein the first function comprises objective and constraint functions of a communication beam, and the second function comprises objective and constraint functions of a dedicated sensing beam; and solving the first function and second function to obtain a communication beamforming vector and a dedicated sensing beamforming vector; if not, assisting in beam alignment by using the fused sensing information; after the beam alignment, assisting in beam tracking by using the fused sensing information.

Please refer to the relevant description of the signal processing system for integrated communication and sensing mentioned above for details.

In the technical solution provided by the embodiment of the present application, the fused sensing information that fuses the uplink and downlink sensing information, the fused CSI estimation value that fuses the uplink and downlink CSI estimation values, and the direction of interest are taken as inputs, and the above prior information is used to assist in beamforming and beam management, thereby improving the ability to suppress mutual interference between communication and sensing, and further improving communication and sensing performance.

In some embodiments, an uplink reception communication beamforming vector and a downlink transmission communication beamforming vector are the same.

Please refer to the relevant description of the signal processing system for integrated communication and sensing mentioned above for details.

In the technical solution provided by the embodiment of the present application, due to the channel reciprocity of TDD system, the access device uses a downlink transmission communication beamforming vector that is the same as the uplink reception communication beamforming vector, which can reduce system complexity and save computing resources.

Corresponding to the signal processing system for integrated communication and sensing mentioned above, an embodiment of the present application further provides a signal processing method for integrated communication and sensing, which is applied to a terminal, the method includes the following steps: performing uplink transmission beamforming and management by using fused sensing information, and transmitting an uplink signal in an uplink time slot based on the uplink transmission beamforming and management.

Please refer to the relevant description of the signal processing system for integrated communication and sensing mentioned above for details.

In the technical solution provided by the present embodiment, the terminal, with the assistance of fused sensing information feedback from the access device, performs uplink transmission beamforming and management, and sends an uplink signal to the access device. Since the access device and the terminal communicate within extremely short continuous transmission and reception time slots, the state of each target in the environment remain basically unchanged. Therefore, the terminal can use the obtained fused sensing information to perform uplink transmission beamforming and management, thereby improving the accuracy of signal transmission, achieving integrated communication and sensing in two-way communication, and further improving environmental sensing ability and the performance of communication optimization process.

In some embodiments, a downlink signal includes a downlink pilot signal and a downlink data signal. The method mentioned above further includes: receiving the downlink signal in a downlink time slot; performing downlink reception beamforming and management on the downlink signal by using the fused sensing information; after receiving the downlink pilot signal, performing channel estimation on the downlink pilot signal to obtain a downlink CSI estimation value; after receiving the downlink data signal, demodulating the downlink data signal by using the fused CSI estimation value.

Please refer to the relevant description of the signal processing system for integrated communication and sensing mentioned above for details.

In the technical solution provided by the embodiments of the present application, due to the channel reciprocity of the TDD system within coherent time, the access device can fuse the uplink and downlink CSI estimation values to obtain the fused CSI estimation value, and the terminal can use the fused CSI estimation value for communication demodulation to improve the accuracy of channel estimation, thereby enhancing the communication reliability.

In some embodiments, performing uplink transmission beamforming and management by using fused sensing information may include: performing uplink transmission beamforming and management by using the fused sensing information and the fused CSI estimation value;
performing downlink reception beamforming and management on the downlink signal by using the fused sensing information may include: performing downlink reception beamforming and management on the downlink signal by using the fused sensing information and the fused CSI estimation value.

Please refer to the relevant description of the signal processing system for integrated communication and sensing mentioned above for details.

In the technical solution provided by the embodiment of the present application, the beamforming and management is performed by using the fused sensing information and the fused CSI estimation value with higher accuracy, thereby further improving sensing performance and enhancing communication performance such as a signal-to-noise ratio and reliability of uplink and downlink communication.

An embodiment of the present application further provides an access device, as shown in FIG. 14, which includes a processor 141, a communication interface 142, a memory 143, and a communication bus 144, wherein the processor 141, the communication interface 142, and the memory 143 communicate with each other through the communication bus 144,
the memory 143 is configured to store a computer program;
the processor 141 is configured to, when executing the program stored on the memory 143, implement any step of the signal processing method for integrated communication and sensing applied to the access device as described above.

An embodiment of the present application further provides a terminal, as shown in FIG. 15, which includes a processor 151, a communication interface 152, a memory 153, and a communication bus 154, wherein the processor 151, the communication interface 152, and the memory 153 communicate with each other through the communication bus 154,
the memory 153 is configured to store a computer program;
the processor 151 is configured to, when executing the program stored on the memory 153, implement any step of the signal processing method for integrated communication and sensing, applied to the terminal as described above.

The communication bus mentioned in the above access device and terminal can be a Peripheral Component Interconnect (PCI) standard bus or an Extended Industry Standard Architecture (EISA) bus, etc. The communication bus can be divided into an address bus, a data bus, a control bus, etc. For ease of representation, only one thick line is used in the figure, but it does not mean that there is only one bus or one type of bus.

The communication interface is used for the communication between the above electronic device and other devices.

The memory may include a Random Access Memory (RAM), and may also include a Non-Volatile Memory (NVM), such as at least one disk memory. Optionally, the memory may also be at least one storage device located far away from the aforementioned processor.

The above processor can be a general-purpose processor, including a Central Processing Unit (CPU), a Network Processor (NP), etc.; it can also be a Digital Signal Processor (DSP), an Application Specific Integrated Circuit (ASIC), a Field-Programmable Gate Array (FPGA) or other programmable logic devices, discrete gates or transistor logic devices, or discrete hardware components.

In yet another embodiment provided by the present application, a computer-readable storage medium is further provided, which stores a computer program thereon, that when executed by a processor, implements any step of the signal processing method for integrated communication and sensing, applied to the access device or terminal as described above.

In yet another embodiment provided by the present application, a computer program product containing instructions is further provided, that when running on a computer, cause the computer to carry out any of the signal processing method for integrated communication and sensing, applied to the access device or terminal in the above mentioned embodiments.

In the above embodiment, it can be realized in whole or in part by software, hardware, firm ware or any combination thereof. When implemented by software, it can be realized in the form of a computer program product in whole or in part. The computer program product comprises one or more computer instructions. When the computer program instruction is loaded and executed on the computer, the flow or function described in the embodiment of the present application is generated in whole or in part. The computer can be a general purpose computer, a special purpose computer, a computer network, or other programmable devices. The computer instructions can be stored in a computer-readable storage medium, or transferred from one computer-readable storage medium to another. For example, the computer instruction can be transferred from a website, a computer, a server or data center to another website site, computer, server or data center through by wire (such as coaxial cable, optical fiber, digital subscriber line (DSL)) or wirelessly (such as infrared, wireless, microwave, etc.). The computer-readable storage medium can be any available medium that can be accessed by a computer or a data storage device comprising a server, a data center and the like that includes an integration of one or more available medium. The available medium can be magnetic media (for example, floppy disk, hard disk, magnetic tape), optical media (for example, DVD), or semiconductor media (for example, solid state disk (SSD)).

It should be noted that in this article, relational terms such as first and second are only to distinguish one entity or operation from another entity or operation, and do not necessarily require or imply any actual relationship or order between these entities or operations. Moreover, the terms “comprise”, “include”, or any other variation thereof are intended to encompass non-exclusive inclusion, such that a process, method, item, or device that comprises a series of elements not only comprises those elements, but also other elements that are not explicitly listed, or also comprise elements inherent in such a process, method, item, or device. Without further limitations, the elements limited by the statement “comprising one . . . ” do not exclude the existence of other identical elements in the process, method, item, or device that comprises the elements.

The various embodiments in this specification are described in a relevant manner. Each embodiment focuses on the differences from other embodiments, and the same and similar parts between the various embodiments can be referred to each other. In particular, for the embodiments of the integrated communication and sensing signal processing method, the access device, the terminal, the computer program products, and the computer-readable storage medium, the description is relatively simple because it is basically similar to the embodiment of the method, and the relevant points can be referred to the partial description of the embodiment of the method.

The above is only a preferred embodiment of the present application and is not intended to limit the scope of protection of the present application. Any modification, equivalent replacement, improvement, etc. made within the spirit and principles of the present application shall be included in the scope of protection of the present application.

1. A signal processing system for integrated communication and sensing, wherein the system comprises a first signal processing module, a sensing fusion module, a first signal transmission module that are deployed on an access device, and a second signal transmission module deployed on a terminal side, wherein the first signal processing module is connected to the sensing fusion module, and the sensing fusion module is connected to the first signal transmission module;
wherein the second signal transmission module is configured for performing uplink transmission beamforming and management by using fused sensing information, and sending an uplink signal in an uplink time slot based on the uplink transmission beamforming and management;
the first signal processing module is configured for receiving the uplink signal in the uplink time slot and receiving an echo signal of a downlink signal in a downlink time slot, and performing incident angle estimation, performing reception beamforming and management, performing range and Doppler frequency shift estimation on the uplink signal and the echo signal respectively by using the fused sensing information to obtain first sensing information of the uplink signal and second sensing information of the echo signal;
the sensing fusion module is configured for updating the fused sensing information based on the first sensing information and the second sensing information;
the first signal transmission module is configured for performing downlink transmission beamforming and management by using the fused sensing information, and sending a downlink signal in a downlink time slot based on the downlink transmission beamforming and management.

2. The system according to claim 1, wherein the uplink signal comprises an uplink pilot signal and an uplink data signal, and the downlink signal comprises a downlink pilot signal and a downlink data signal;
the system further comprises a first channel estimation module, a CSI fusion module, and a first communication demodulation module that are deployed on the access device, and a second signal processing module, a second channel estimation module, and a second communication demodulation module that are deployed on the terminal side, wherein the first channel estimation module and the first communication demodulation module are respectively connected to the first signal processing module, the CSI fusion module is connected to the first channel estimation module, the second channel estimation module and the second communication demodulation module are respectively connected to the second signal processing module;
wherein the first channel estimation module is configured for performing, after receiving the uplink pilot signal, channel estimation on the uplink pilot signal to obtain an uplink CSI estimation value;
the second signal processing module is configured for receiving the downlink signal in the downlink time slot; performing downlink reception beamforming and management on the downlink signal by using the fused sensing information;
the second channel estimation module is configured for performing, after receiving the downlink pilot signal, channel estimation on the downlink pilot signal to obtain a downlink CSI estimation value;
the CSI fusion module is configured for updating a fused CSI estimation value based on the uplink CSI estimation value and the downlink CSI estimation value;
the first communication demodulation module is configured for demodulating, after receiving the uplink data signal, the uplink data signal by using the fused CSI estimation value;
the second communication demodulation module is configured for demodulating, after receiving the downlink data signal, the downlink data signal by using the fused CSI estimation value.

3. The system according to claim 2, wherein the CSI fusion module is specifically configured for:
estimating error values corresponding to the uplink CSI estimation value and the downlink CSI estimation value by using a matrix of received signals;
fusing the uplink CSI estimation value and the downlink CSI estimation value by using the obtained error values, to obtain the fused CSI estimation value.

4. The system according to claim 1, wherein the downlink signal comprises a downlink pilot signal, a downlink data signal, and an active detection signal;
wherein the first signal transmission module is specifically configured for sending the downlink pilot signal and the downlink data signal in the direction of the terminal in a downlink time slot, and sending the active detection signal in a direction of interest in the downlink time slot;
the first signal processing module is specifically configured for receiving an echo signal of the downlink pilot signal, an echo signal of the downlink data signal, and an echo signal of the active detection signal in the downlink time slot.

5. The system according to claim 1, wherein the first sensing information and the second sensing information comprise sensing information corresponding to multiple targets; wherein the sensing fusion module is specifically configured for:
estimating a signal-to-noise ratio of each target for sensing by using a matrix of received signals;
estimating an error value of the sensing information corresponding to each target by using the signal-to-noise ratio of each target for sensing; and
fusing the sensing information corresponding to each target by using the error value corresponding to each target to obtain the fused sensing information.

6. The system according to claim 2, wherein the second signal transmission module is specifically configured for performing uplink transmission beamforming and management by using the fused sensing information and the fused CSI estimation value;
the first signal processing module is specifically configured for performing reception beamforming and management by using the fused sensing information and the fused CSI estimation value;
the first signal transmission module is specifically configured for performing downlink transmission beamforming and management by using the fused sensing information and the fused CSI estimation value; and
the second signal processing module is specifically configured for performing downlink reception beamforming and management by using the fused sensing information and the fused CSI estimation value.

7. The system according to claim 6, wherein the first signal processing module and the first signal transmission module are specifically configured for:
determining whether it is in a beamforming stage;
if so, generating a reference channel by using the fused sensing information; generating a first function by using the reference channel and the fused CSI estimation value, and generating a second function by using the reference channel and information about a direction of interest, wherein the first function comprises objective and constraint functions of a communication beam, and the second function comprises objective and constraint functions of a dedicated sensing beam; and solving the first function and second function to obtain a communication beamforming vector and a dedicated sensing beamforming vector;
if not, assisting in beam alignment by using the fused sensing information; after the beam alignment, assisting in beam tracking by using the fused sensing information.

8. The system according to claim 1, wherein an uplink reception communication beamforming vector and a downlink transmission communication beamforming vector are the same.

9. A signal processing method for integrated communication and sensing, wherein the method is applied to an access device, and the method comprises:
receiving an uplink signal in an uplink time slot and receiving an echo signal of a downlink signal in a downlink time slot;
performing incident angle estimation, performing reception beamforming and management, performing range and Doppler frequency shift estimation on the uplink signal and the echo signal respectively by using fused sensing information to obtain first sensing information of the uplink signal and second sensing information of the echo signal;
updating the fused sensing information based on the first sensing information and the second sensing information;
performing downlink transmission beamforming and management by using the fused sensing information, and sending a downlink signal in a downlink time slot based on the downlink transmission beamforming and management.

10. The method according to claim 9, wherein the uplink signal comprises an uplink pilot signal and an uplink data signal, the method further comprises:
performing, after receiving the uplink pilot signal, channel estimation on the uplink pilot signal to obtain an uplink CSI estimation value;
updating a fused CSI estimation value based on the uplink CSI estimation value and a downlink CSI estimation value;
demodulating, after receiving the uplink data signal, the uplink data signal by using the fused CSI estimation value.
